(19) United States
(12) Patent Application Publication
(10) Pub. No.: US 2019/0333109 A1
(43) Pub. Date: Oct. 31, 2019

(54) Head-Mountable Display

(71) Applicant: Google LLC, Mountain View, CA (US)

(72) Inventor: Eric Teller, San Francisco, CA (US)

(73) Assignee: Google LLC, Mountain View, CA (US)

(21) Appl. No.: 14/278,937

(22) Filed: May 15, 2014

Related U.S. Application Data
(63) Continuation of application No. 13/428,991, filed on Mar. 23, 2012, now abandoned.

(51) Int. Cl. G06Q 30/02

(52) U.S. Cl. CPC G06Q 30/0267

(57) ABSTRACT

Methods and systems may help to determine where to locate advertisements in a head-mountable device with a see-through display. A method may involve: (a) receiving gaze data that is indicative of a wearer-view that is associated with a head-mountable device (HMD), wherein the HMD comprises a see-through display; (b) selecting a given advertisement for display in the see-through display; (c) analyzing the gaze data to determine a portion of the wearer-view that is suitable as an advertising background; and (d) sending an ad-display message to the HMD, wherein the ad-display message indicates to display the given advertisement at a location in the see-through display that corresponds, in the wearer-view, with the determined portion of the wearer-view.

### RELATED APPLICATION

This patent application is a continuation of U.S. patent application Ser. No. 13/428,991, filed on Mar. 23, 2012, the contents of which are entirely incorporated herein by reference, as if fully set forth in this application.

### BACKGROUND

Unless otherwise indicated herein, the materials described in this section are not prior art to the claims in this application and are not admitted to be prior art by inclusion in this section.

Computing devices such as personal computers, laptop computers, tablet computers, cellular phones, and countless types of Internet-capable devices are increasingly prevalent in numerous aspects of modern life. Over time, the manner in which these devices are providing information to users is becoming more intelligent, more efficient, more intuitive, and/or less obtrusive.

The trend toward miniaturization of computing hardware, peripherals, as well as of sensors, detectors, and image and audio processors, among other technologies, has helped open up a field sometimes referred to as “wearable computing.” In the area of image and visual processing and production, in particular, it has become possible to consider wearable displays that place a very small image display element close enough to a wearer's (or user's) eye(s) such that the displayed image fills or nearly fills the field of view, and appears as a normal sized image, such as might be displayed on a traditional image display device. The relevant technology may be referred to as “near-eye displays.”

Near-eye displays may be components of wearable displays, such as “head-mountable displays” (HMDs). A head-mountable display may place a graphic display or displays close to one or both eyes of a wearer. To generate the images on a display, a computer processing system may be used. Such displays may occupy a wearer's entire field of view, or only occupy part of wearer's field of view.

Emerging and anticipated uses of wearable displays include applications in which users interact in real time with an augmented or virtual reality. Such applications can be mission-critical or safety-critical, such as in a public safety or aviation setting. The applications can also be recreational, such as interactive gaming.

### SUMMARY

In an aspect, a computer-implemented method may involve: (a) receiving gaze data that is indicative of a wearer-view that is associated with a head-mountable device (HMD), wherein the HMD comprises a see-through display; (b) selecting a given advertisement for display in the see-through display; (c) analyzing the gaze data to determine a portion of the Fwearer-view that is suitable as an advertising background; and (d) sending an ad-display message to the HMD, wherein the ad-display message indicates to display the given advertisement at a location in the see-through display that corresponds, in the wearer-view, with the determined portion of the wearer-view.

In another aspect, a system includes a non-transitory computer-readable medium and program instructions stored on the non-transitory computer-readable medium. The program instructions are executable by at least one processor to: (a) receive gaze data that is indicative of a wearer-view that is associated with a head-mountable device (HMD), wherein the HMD comprises a see-through display; (b) select a given advertisement for display in the see-through display; (c) analyze the gaze data to determine a portion of the wearer-view that is suitable as an advertising background; and (d) send an ad-display message to the HMD, wherein the ad-display message indicates to display the given advertisement at a location in the see-through display that corresponds, in the wearer-view, with the determined portion of the wearer-view.

In yet another aspect, a computer-implemented method may involve a wearable computing device that comprises a see-through display: (a) receiving gaze data that is indicative of a wearer-view through a see-through display; (b) analyzing the gaze data to determine at least one aspect of the wearer-view that is suitable as a background for advertising; (c) sending an ad-space availability message that indicates the at least one determined aspect of the wearer-view; (d) receiving an ad-display message that is responsive to the ad-space availability message, wherein the ad-display message indicates an advertisement; and (e) displaying the indicated advertisement at a location in the see-through display that substantially aligns, in the wearer-view, with the determined aspect of the wearer-view.

These as well as other aspects, advantages, and alternatives, will become apparent to those of ordinary skill in the art by reading the following detailed description, with reference where appropriate to the accompanying drawings.

### BRIEF DESCRIPTION OF THE DRAWINGS

FIG. 1 is a flow chart illustrating a method, according to an exemplary embodiment.

FIG. 2A is a simplified illustration of an advertisement that visually highlights an aspect of a wearer-view, according to an exemplary embodiment.

FIG. 2B is a simplified illustration of another advertisement that visually highlights an aspect of the same wearer-view shown in FIG. 2A.

FIG. 2C is a simplified illustration of another advertisement that visually highlights an aspect of a wearer-view, according to an exemplary embodiment.

FIG. 3A is a simplified illustration of an advertisement that visually highlights an aspect of another wearer-view, according to an exemplary embodiment.

FIG. 3B is a simplified illustration of another advertisement that visually highlights an aspect of wearer-view, according to an exemplary embodiment.

FIG. 4 is an illustration of a scenario in which an advertisement may be selected to augment a real-world aspect of the wearer-view, according to an exemplary embodiment.

FIG. 5A is a simplified illustration of a real-world field of view, according to an embodiment.

FIG. 5B is a simplified illustration of another real-world field of view, according to an embodiment.

FIG. 5C is another simplified illustration of a real-world field of view, according to an embodiment.

FIG. 6A illustrates a wearable computing system, according to an exemplary embodiment.

FIG. 6B illustrates an alternate view of the wearable computing device illustrated in FIG. 6A.

FIG. 6C illustrates another wearable computing system according to an exemplary embodiment.

FIG. 6D illustrates another wearable computing system according to an exemplary embodiment.

FIG. 7 illustrates a schematic drawing of a computing device according to an exemplary embodiment.

FIG. 8 is a simplified block diagram illustrating a communication network via which gaze data may be received, according to an exemplary embodiment.

### DETAILED DESCRIPTION

Exemplary methods and systems are described herein. It should be understood that the word “exemplary” is used herein to mean “serving as an example, instance, or illustration.” Any embodiment or feature described herein as “exemplary” is not necessarily to be construed as preferred or advantageous over other embodiments or features. The exemplary embodiments described herein are not meant to be limiting. It will be readily understood that certain aspects of the disclosed systems and methods can be arranged and combined in a wide variety of different configurations, all of which are contemplated herein.

### I. Overview

An embodiment may be implemented in the context of an advertising system that selects advertisements for display at a head-mountable display (HMD). A head-mountable display (HMD) may capture gaze data that is indicative of what the wearer of the HMD is looking at (or would have been looking it, in the event the HMD is not being worn). The gaze data may take the form of or include point-of-view (POV) video from a camera mounted on an HMD. As such, an advertisement server may analyze gaze data that is associated with a given HMD, and thus assumed to be associated with the HMD's wearer, and select advertisements that relate to what the wearer is currently looking at.

Further, an HMD may include a see-through display (either optical or video see-through), such that computer-generated graphics can be overlaid on the wearer's view of their real-world (i.e., physical) surroundings. In this configuration, it may be beneficial to display an advertisement at a location in the see-through display that aligns with a portion of the real-world surroundings that provide a suitable background for the advertisement. As such, methods and systems may help to identify aspects of the wearer's real-world field of view that provide a suitable background for advertisements that are displayed in an HMD's see-through display.

To identify a suitable real-world background for display of an advertisement in an HMD, a server system may evaluate visual characteristics of the POV video that is captured at the HMD. For instance, to evaluate a given portion of the POV video, a server system may consider a visual characteristic or characteristics such as the permanence level of real-world objects and/or features relative to the wearer's field of view, the coloration in the given portion, and/or visual pattern in the given portion, and/or the size and shape of the given portion, among other factors. Measures of such visual characteristics may be determined and used to determine an “ad-suitability value” for a given portion of the wearer's field of view. The ad-suitability value may also be based on relationships between these and other factors, and may also be based upon context information and/or other factors.

For example, to an HMD wearer that is standing on the sidewalk, an area that is more permanent, such as the surface of a billboard, may have a higher ad-suitability value than a bumper of a car that is driving by rapidly. However, there may be aspects of wearer's surroundings that are relatively permanent over a certain period of time, i.e., enough time for an advertisement to be displayed, such that these aspects can provide a suitable background for display of an advertisement by an HMD. As another example, an advertisement server may analyze gaze data from an HMD, and detect that two people with white shirts are standing next to each other. Further, the server may determine that the two people have been standing next to each other for a certain period of time, and that one has their arm around the other (indicating they are likely to continue to stand next to one another). In this scenario, the advertisement server may determine that the area across the back of both of their shirts can collectively provide a background for an advertisement displayed by the HMD. Other examples are also possible.

Note that in the above example, evaluating the permanence of real-world aspects in the wearer's field of view, helped to identify a non-traditional advertisement space (e.g., across the backs of both white shirts), such that it could be used more effectively for advertising. Further, as the above example also illustrates, some implementations may allow surfaces that might typically be thought of as separate ad spaces to be combined as a single ad space, given the appropriate circumstances.

In some embodiments, the HMD may display augmented-reality advertisements, which graphically highlight aspects of the physical world that the wearer is viewing. For example, if an ad server detects a sign for a coffee shop in gaze data from an HMD, then the ad server may instruct the HMD to highlight the sign in the wearer's field of view by, for example, displaying a line surrounding the sign or an arrow directed at the sign, in the HMD. The line and/or arrow may then be located and/or moved within the HMD so as to keep the line and/or arrow substantially aligned with the sign in the wearer's field-of-view. Other examples are also possible.

Augmented-reality advertisements may also take other forms, which don't necessarily highlight an aspect of the physical world, but relate to the physical word in some other way. For example, when a product is detected in gaze data from an HMD, the HMD may display additional information about the product or a comparison to a competing product such that the additional information or comparison appears to be next to the product the wearer is looking at.

In other embodiments, the HMD may display advertisements to appear in a “picture-in-picture” style in the wearer's field of view (e.g., with the advertisement being a smaller picture within the larger picture of the wearer's real-world field-of-view). For instance, in the above scenario where an ad server detects a sign for a coffee shop in gaze data, the ad server may additionally or alternatively send the HMD an advertisement, such as a coupon for coffee, for display in the HMD. The advertisement may be displayed at a fixed location in the HMD, and further, may be located in the display such that the advertisement appears in the periphery of the wearer's field-of-view.

Note that an “advertisement” need not be a direct attempt to sell a good or service, and could generally be anything that someone pays to be displayed to someone. For example, a band could pay to have a music video for their song played back in an HMD, without directly offering to sell the song.

Also note that when gaze data is said to be associated with a given user-account, it should generally be understood that this gaze data was sent by a device that is associated with the given user-account (e.g., a device that is registered with the user-account). Further, gaze data and/or other information that is associated with a user-account may also be said to be associated with a user since, functionally, associating gaze data or any other data with a user will generally be accomplished by associating the data with the user's user account.

In a further aspect, when a user creates a user-account, a user-profile for the user-account may be created as well. The user-profile may include or provide access to various types of information, from various sources, which is related to the user. For simplicity, examples set forth herein may simply refer to a user-account as including the information included in the associated user-profile. However, this should not be read as requiring that a user-account include a user-profile. It is possible, in some embodiments, that a user-account may not have an associated user-profile. Furthermore, herein, the term user-profile may more generally be understood to refer to any information or collection of information related to a given user. As such, a user-profile may be specifically created for a user-account or may simply take the form of data that is associated with a given user.

### II. Method Examples

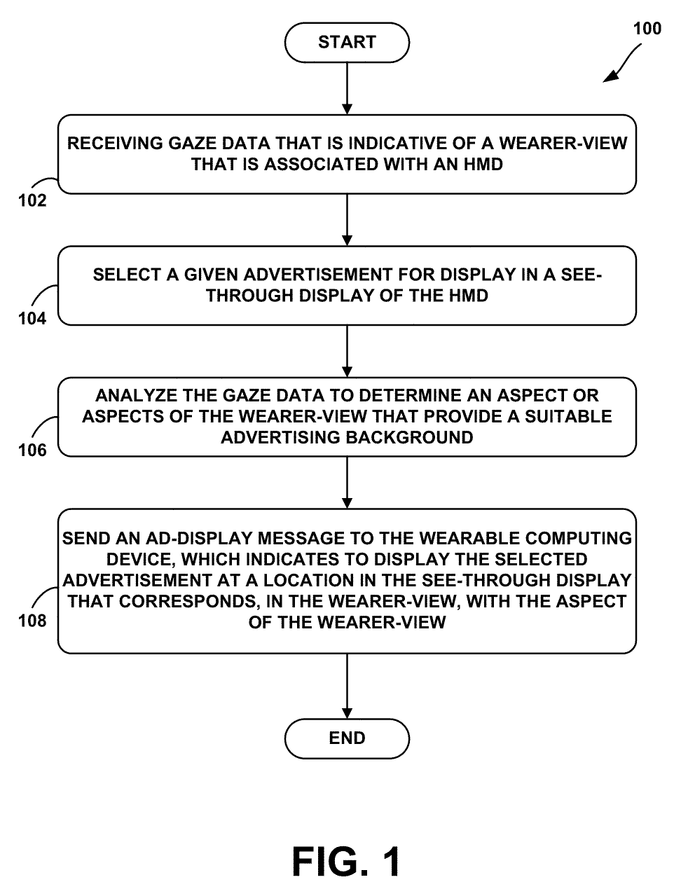

FIG. 1 is a flow chart illustrating a method 100, according to an embodiment. The method 100 shown in FIG. 1 is described by way of example as being carried out by a server system (e.g., an ad-selection system) in order to provide gaze-based customization of advertisements to HMDs. However, it should be understood that methods, such as method 100, may be carried out by other systems or combinations of systems, without departing from the scope of the invention.

As shown by block 102, method 100 involves the server system receiving gaze data that is indicative of a wearer-view that is associated with an HMD. The server system then selects a given advertisement for display in a see-through display of the HMD, as shown by block 104. The server system may also analyze the gaze data to determine an aspect or aspects of the wearer-view that provide a suitable advertising background, as shown by block 106. The server system can then send an ad-display message to the wearable computing device, which indicates to display the selected advertisement at a location in the see-through display that corresponds, in the wearer-view, with the aspect of the wearer-view, as shown by block 108.

In a further aspect, method 100 or portions thereof may be implemented periodically or continually in order to update the portion of the wearer-view that provides a suitable advertisement background for the selected advertisement, as the wearer-view changes over time. As such, method 100 may further involve periodically or continually updating the location of an advertisement, as the wearer moves and the wearer-view changes.

For example, after a server initially sends an ad-display message to an HMD, the server may monitor gaze data from the HMD to determine whether the advertisements that is being displayed is no longer located in the display so as to align with a suitable real-world background in the wearer's field of view, and/or to determine if there is another aspect that is more suitable for an advertisement than the aspect that is currently providing the background for the advertisement. When such a scenario is detected, the server system may send an update message to the HMD to indicate that the advertisement should change the location of the advertisement such that the advertisement corresponds in the wearer-view, to the newly identified aspect of the wearer-view.

A. Receiving Gaze Data

As noted, block 102 of method 100 involves the server system receiving gaze data that is associated with a certain HMD. Gaze data may be received at a server system using various forms of wired and/or wireless communication. However, it should be understood that the particular manner in which the gaze data is received should not be construed as limiting, unless explicitly stated otherwise.

Gaze data may be captured at the HMD, and may be indicative of the wearer-view associated with the HMD. In particular, the gaze data may take the form of or include point-of-view (POV) image data captured at the HMD. As such, the gaze data may be indicative of what the wearer of the HMD is seeing in and/or through the display of the HMD (e.g., what is in the field of view of the wearer).

In some embodiments, the gaze data from a wearable computing device may take the form of point-of-view video that is captured at the wearable computing device. As such, the POV video may be analyzed to detect aspects of the wearer view that provide information that can be used to select an advertisement for display to the wearer in the HMD. To do so, two or more frames from the POV video may be analyzed in order to select an ad that is related to or is otherwise appropriate to the wearer's situation or experience or aspects thereof.

Gaze data may take other forms in addition or in the alternative to POV video. For example, gaze data associated with a given wearable computing device may take the form of point-of-view images captured by a forward- or outward-facing camera on an HMD. As a specific example, an HMD may periodically take a picture, and then send the picture to an advertisement server system for use in generating wearer view data. Other examples are also possible.

Note also that when the wearer is wearing an HMD, the wearer-view may include both (i) real-world aspects (e.g., aspects of the wearer's real-world surroundings that the wearer sees through an optical see-through display, or as seen replicated on a video see-through display), and (ii) virtual aspects (e.g., graphics that are displayed in the HMD's see-through display). An exemplary method may take into account just the real-world aspects of the wearer-view, or both the real-world and virtual aspects, depending upon the implementation.

For example, a server system may analyze POV video captured at the HMD for real-world aspects captured in the POV video. By virtue of being captured in the POV video, the server system may determine that real-world aspects captured in the POV video are within the wearer's field of view. An ad-selection process may thus select an advertisement that relates to one or more real-world aspects of what the wearer is viewing. Other examples are also possible.

Further, when the wearer-view is represented by POV video, the server system may only analyze a portion of a video or still image when searching for a suitable advertising background. In particular, the server system may analyze the portion of the video that corresponds to the portion of the field-of-view that typically serves as the background to a translucent display of an HMD. Thus, it should be understood, however, that the server system may analyze the entire POV video frame and/or another portion of the video, without departing from the scope of the invention.

B. Selection of an Advertisement for Display at a Head-Mountable Display

As noted above, block 104 of method 100 involves the server system selecting an advertisement for display at the HMD. This type of process, that involves the selection of an advertisement for display at an HMD, may be referred to herein as an “ad-selection process.” Various types of information, from various sources, may be taken into account during the ad-selection process.

In some embodiments, the selection of the advertisement may be based upon the gaze data that is received from the HMD at block 102. In particular, the server system may select an advertisement based on the wearer-view associated with the HMD. Additionally or alternatively, the server system may consider factors such as the user-profile associated with the HMD (e.g., the user-profile of the wearer) and/or an advertiser-value that is associated with display of the advertisement at the HMD (e.g., a value that is indicative of how much it is worth to the advertiser to display the advertisement at the HMD). The server system may also consider other factors in the ad-selection process

In some embodiments, the server system may consider factors such as the current wearer-view, the user-profile associated with the HMD, and/or the value to the advertiser of displaying various candidate advertisements, in an effort to select an advertisement that will both interest the wearer and provide value to the wearer.

For example, the ad-selection process may seek to balance the wearer's interest in the selected advertisement with the value to the advertiser of having the advertisement displayed to the wearer in their HMD. To do so, the server system may determine an interest value for a candidate advertisement. The interest value may be based at least in part on the user-profile associated with the HMD, and may thus be considered to be indicative of the wearer's interest level in the candidate advertisement. The server system may also determine the advertiser-value for the candidate advertisement. The server system can then use the interest value, the advertiser-value, and possibly other factors, to determine an overall display value that is associated with selecting the advertisement for display at the HMD. This process may be repeated for a number of candidate advertisements, and the advertisement having the highest overall display value may be selected.

Further, in some implementations, the ad-selection process may take other factors into account, in addition or in the alternative to the wearer-view, the user-profile, and/or the advertiser-value of displaying advertisements. As one example, priority status and/or preferences for certain advertisements may also be taken into account when selecting an advertisement. As a specific example, in some embodiments, advertisers may be allowed to pay for priority placement of their advertisements, such that chances of their advertisement being displayed in some or all scenarios are increased. Other examples of priority and/or preference being given to certain advertisements are also possible.

Yet further, at block 104 of method 100, various types of advertisements may be selected for display by an HMD. The advertisements may include graphics and possibly audio as well. For example, advertisements may include text, images, movies, user-interfaces (e.g., interactive components), audio data, and/or a computer application, among other possibilities.

In some implementations, an “augmented-reality” advertisement may be selected for display in an HMD. When displayed in the display of an HMD, an augmented-reality advertisement may be perceived by the wearer of the HMD as augmenting an aspect of their real-world field of view.

An augmented-reality advertisement may take the form of a visual highlight, which visually augments at least one aspect of the wearer-view. Visual highlights may generally be any type of graphic that, when displayed on the HMD, may help to emphasize or draw attention to an aspect of the wearer-view. Examples of visual highlights include, but are not limited to: (a) one or more arrows that are directed that appear, in the wearer-view, to be directed at an aspect of the wearer-view, (b) an outline of an aspect in the wearer-view, and/or (c) a graphic overlay that is substantially aligned in the wearer-view with the detected aspect of the wearer view, among others.

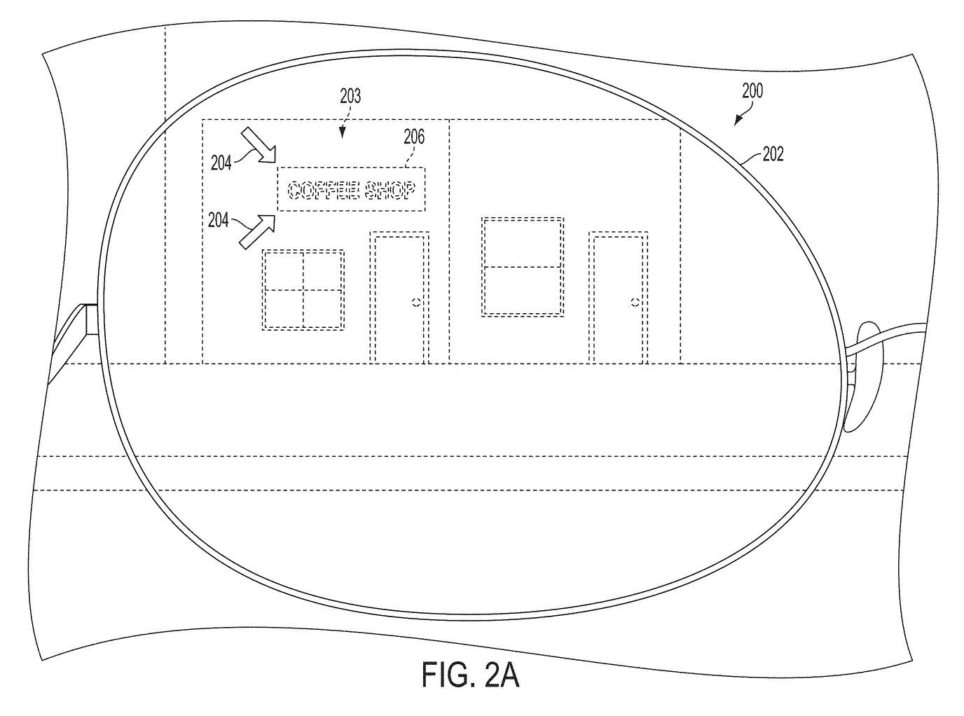

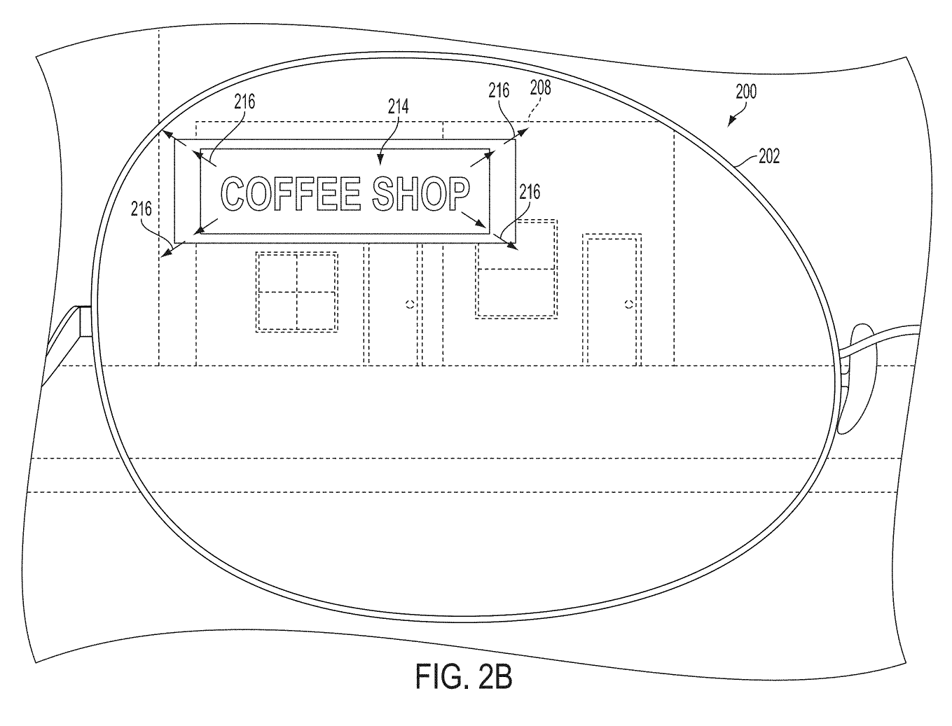

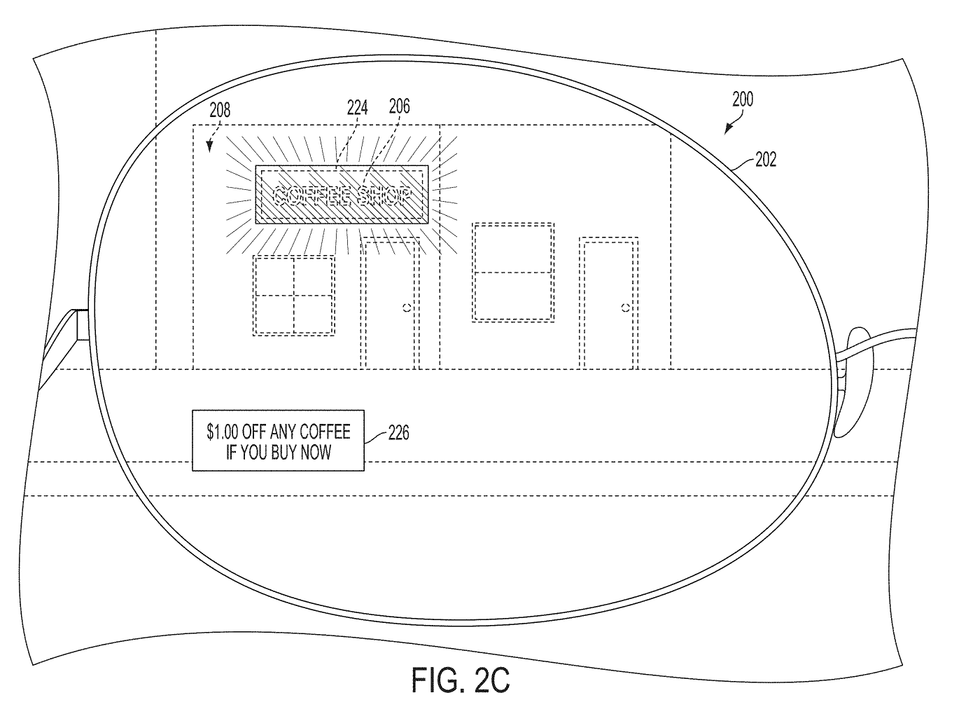

As an example, FIG. 2A is a simplified illustration of an advertisement that visually highlights an aspect of a wearer-view 200, according to an exemplary embodiment. More specifically, in FIG. 2A, HMD 202 is displaying arrows 204 in its display, such that the arrows 204 align with “Coffee Shop” sign 206 in the field of view of a person wearing the HMD 202. As such, arrows 204 are visual highlights that help to advertise coffee shop 208 by directing the wearer's attention to the “Coffee Shop” sign 206.

Visual highlights that serve as advertisements may take various other forms. For example, FIG. 2B is a simplified illustration of another advertisement that visually highlights an aspect of wearer-view 200. More specifically, in FIG. 2B, HMD 202 is displaying a “Coffee Shop” graphic 214 such that the graphic substantially aligns with the coffee shop 208 in the field of view of the person wearing HMD 202. As such, “Coffee Shop” graphic 214 is a visual highlight, which may help to advertise for coffee shop 208 by directing the wearer's attention to the “Coffee Shop” graphic 214.

As an additional example, FIG. 2C is a simplified illustration of another advertisement that visually highlights an aspect of a wearer-view 200, according to an exemplary embodiment. More specifically, in FIG. 2C, HMD 202 is displaying a translucent graphic 224 such that the graphic is overlaid on “Coffee Shop” sign 206 in the field of view of the person wearing HMD 202. In an exemplary embodiment, the translucent graphic 224 may be colorful (e.g., a bright yellow or green) and/or patterned, so as to draw the wearer's attention, while at the same time allowing the wearer to see the real-world aspect of the wearer-view that is being advertised (e.g., “Coffee Shop” sign 206).

In a further aspect, visual highlights, such as arrows 204, “Coffee Shop” graphic 214, and/or translucent graphic 224, may be animated in order to help direct the wearer's attention to an aspect of the wearer view that is being advertised. As an example, referring to FIG. 2B, the “Coffee Shop” graphic 214 may be animated to help draw attention to coffee shop 208. For instance, “Coffee Shop” graphic 214 may be animated so that it appears to move towards the wearer from a surface of coffee shop 208; e.g., by expanding outward along dotted lines 216.

As another example, referring to FIG. 2C, the translucent graphic 224 could be animated to help draw attention to coffee shop 208. For instance, translucent graphic 224 could be flashed in the display of the HMD (e.g., by repeatedly displaying and then removing the graphic from the display). Other animations are possible as well.

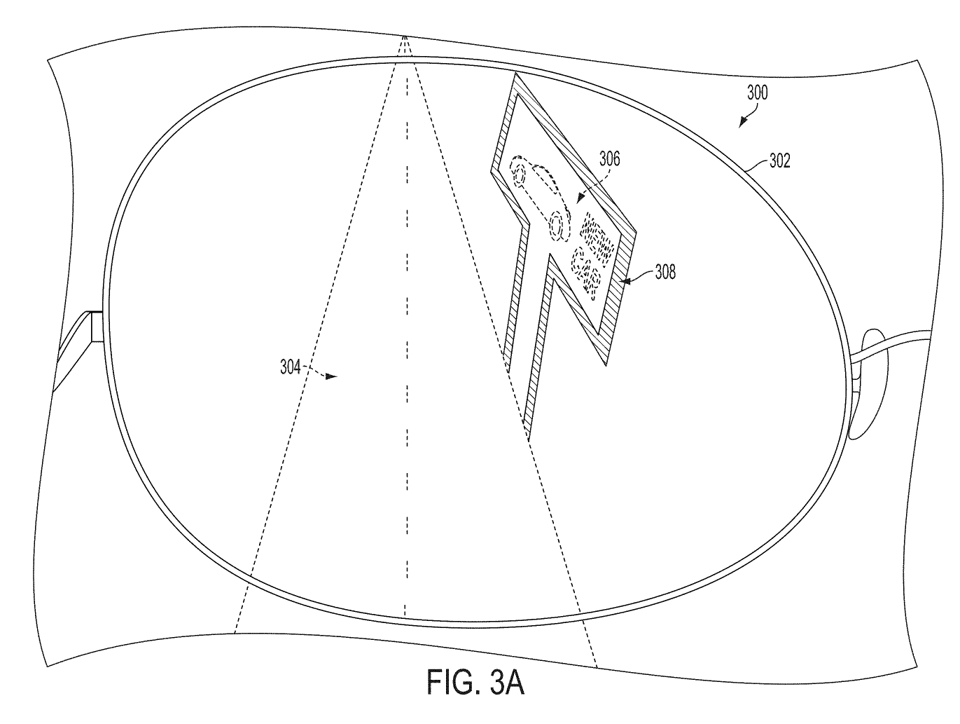

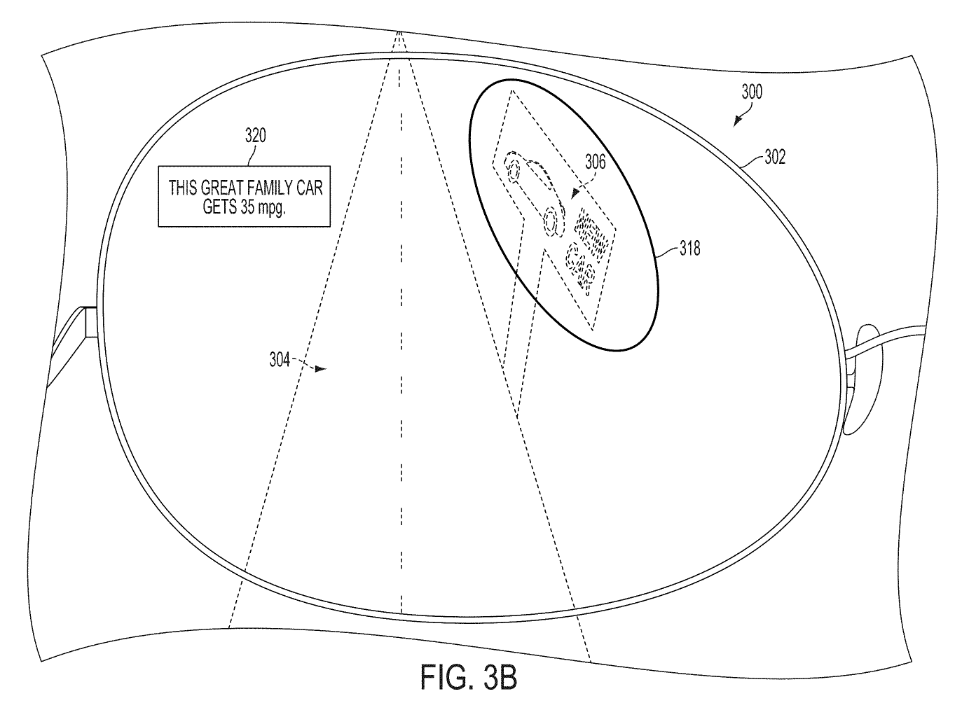

FIG. 3A is a simplified illustration of an advertisement that visually highlights an aspect of another wearer-view 300, according to an exemplary embodiment. More specifically, FIG. 3A illustrates a wearer-view 300 as it may be perceived by the wearer of an HMD 302. As shown, wearer-view 300 includes a road 304 and a billboard 306 with an advertisement for a new car. Further, HMD 302 is displaying an outline 308 such that in the wearer-view, the outline 308 appears to surround the billboard 306. As such, outline 308 is a visual highlight that may help to draw the wearer's attention to the billboard 306.

Note that an outline, and other types of visual highlights that augment an aspect of the wearer-view, may vary in shape and/or size. For example, FIG. 3B is a simplified illustration of another advertisement that visually highlights an aspect of wearer-view 300, according to an exemplary embodiment. More specifically, FIG. 3B shows an outline 318, which is visually different from the outline 308 shown in FIG. 3A. In particular, outline 318 is simply a ring that appears, in the wearer-view, to surround billboard 306.

It should be understood that the examples of visual highlights discussed in relation to FIGS. 2A, 2B, 2C, 3A, and 3B are provided for illustrative purposes, and are not intended to be limiting. Variations on the above-described examples and other types of visual highlights are also possible.

In other implementations, the server system may select an advertisement that does not augment the wearer's view of the real-world. For example, the server may select a “picture-in-picture” style advertisement, which an HMD may display without consideration as to the positioning the ad in its display relative to the view of the real-world. In such an embodiment, there may be a predetermined location in the display that is designated for display of advertisements. As one example, the HMD may display such an advertisement in an application window. Alternatively, a location for display of the advertisement may be dynamically selected based on various criteria.

When a non-augmented-reality advertisement is selected, the advertisement selected at block 104 of method 100 might be displayed by an HMD, without visually augmenting a real-world aspect of the wearer-view 300. For example, referring again to FIG. 3B, an advertisement server may analyze gaze data from HMD 302 and detect that billboard 306 includes an advertisement for a new car. The advertisement server may then select an advertisement in view of the particular wearer's user-profile, which relates to the billboard 306. For instance, the server may take into consideration information from the user-profile that is associated with HMD 302, which indicates that the wearer has two young children and has historically purchased cars that have above-average gas mileage. In light of this information, the advertisement server may create a custom advertisement message that indicates that the new car makes a great family car and gets good gas mileage (e.g., 35 miles per gallon (mpg)). The advertisement server may then send this advertisement message to the HMD 302. The HMD 302 may then display the advertisement message in an advertisement window 320.

Referring back to FIG. 2C, advertisement window 226 provides another example of an advertisement that does not visually augment a particular real-world aspect of the wearer-view 200. In particular, when the coffee shop 208 is detected in gaze data associated with HMD 202, an ad server may responsively select an advertisement that provides a coupon to the coffee shop. The ad server may then indicate to HMD 202 to display an advertisement message that states: “$1.00 off any coffee if you buy now.” When HMD 202 receives this message, it may responsively display the message in advertising window 226 (possibly with a link or another interactive element that allows the wearer to retrieve and/or store the coupon associated with the advertisement message).

C. Determining a Suitable Real-World Background for Display of an Advertisement in a See-Through Display

At block 106 of method 100, various techniques may be used to determine a portion of the wearer-view that provides suitable background for advertising.

In some applications, the server system may identify a portion of the wearer-view that is generally suitable as a background for advertising, without considering the particular advertisement that will be displayed. As such, block 106 of method 100 may further involve the server system using one or more characteristics of the given advertisement as a basis for determining that the portion of the wearer-view is suitable as a background for the given advertisement. For example, if the server system is searching for a suitable background for picture-in-picture advertising, the server system may search for portion of the wearer-view where displaying an advertisement is less likely to be considered disruptive or intrusive.

The server system may then select an advertisement for display in an area of the see-through display that corresponds to the suitable portion, in the wearer-view. In such an implementation, when subsequently selecting the advertisement, the server system may or may consider the relationship between the characteristics of the suitable portion of the wearer-view and the characteristics of one or more candidate advertisement (e.g., appropriate size, color, etc.), in order to select an appropriate advertisement for the portion of the wearer-view.

In some applications, the server system may first select an advertisement, and may subsequently identify a portion of the wearer-view that provides a suitable background for the particular advertisement that was selected. As such, block 106 of method 100 may further involve the server system using one or more characteristics of the selected advertisement as a basis for determining the portion of the wearer-view that is suitable as a background for the selected advertisement. Such characteristics may include, but are not limited to, the length of the video advertisement, a minimize and/or maximum size of the advertisement, a minimum and/or maximum size of text in the advertisement, the context provided by surrounding portions of the wearer-view, and/or the relationship of the content and/or style of the advertisement to the portion of the wearer-view and/or other parts of the wearer-view, among others.

In some embodiments, when selecting the advertisement for a picture-in-picture style advertising, the server system may consider the relationship between the characteristics of the suitable portion of the wearer-view and the characteristics of the selected advertisement (e.g., appropriate size, color, the relationship between the advertisement and aspects in wearer-view and/or the relationship between the advertisement and the HMD's current context). Further, while the advertisement has already been selected, the server system may still adjust characteristics of the selected advertisement to better relate to the characteristics of the suitable portion of the wearer-view. For instance, the server system might resize an advertisement so as to better fit the suitable portion of the wearer-view.

In some applications, the server system may identify the suitable background in the wearer-view and select an advertisement (or a set of candidate advertisements) at substantially the same time. In particular, the server system may include or have access to mapping data that indicates certain characteristics or aspects of the wearer-view that correspond to certain advertisements and/or to certain characteristics of advertisements. Accordingly, the server may monitor gaze data from an HMD and when it detects a portion of the wearer-view with characteristics that map to a particular advertisement, the server system may select the particular advertisement. In some cases, instead of mapping to a particular advertisement, the server system may detect characteristics of the wearer-view that map to a certain type of advertisement and/or to a set of candidate advertisements. In such a case, the server system may then utilize other factors (e.g., context, information from the associated user-profile, advertiser-value, etc.) to select from the candidate advertisements.

Further, at block 106, the suitable aspect of the wearer-view may be determined based on past gaze data. For example, the server system may analyze a POV video segment of a predetermined length (e.g., the last five seconds or the last thirty seconds). A suitable portion of the wearer-view may then be identified by, e.g., identifying a region in the video that has suitable visual characteristics for an advertisement in at least a threshold number or threshold percentage of frames during the segment. A similar process may be implemented using a sequence of POV still images instead of video frames.

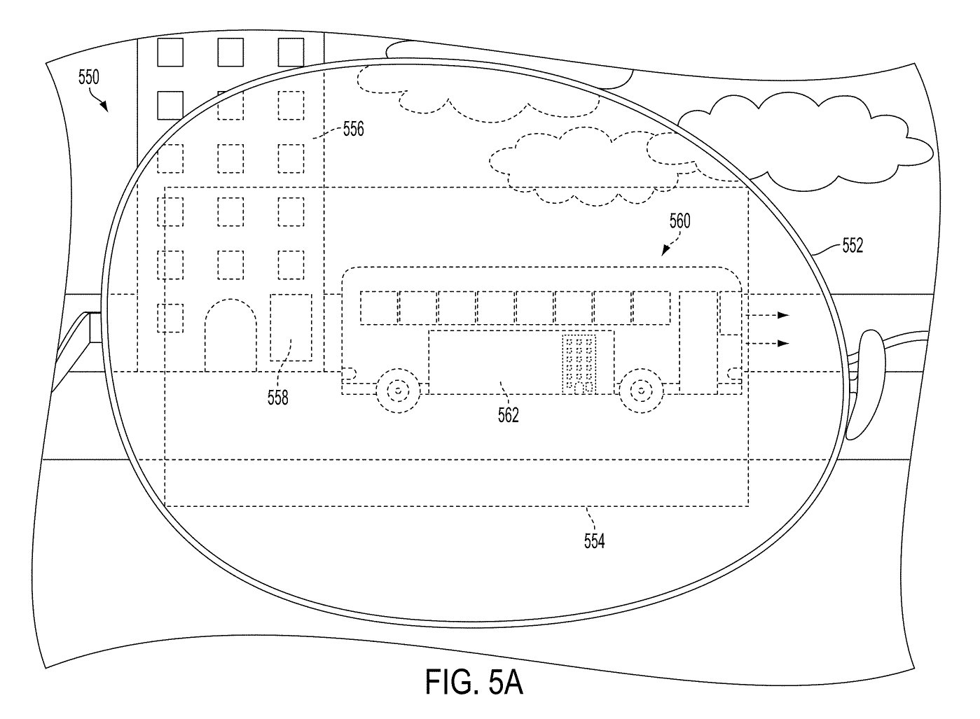

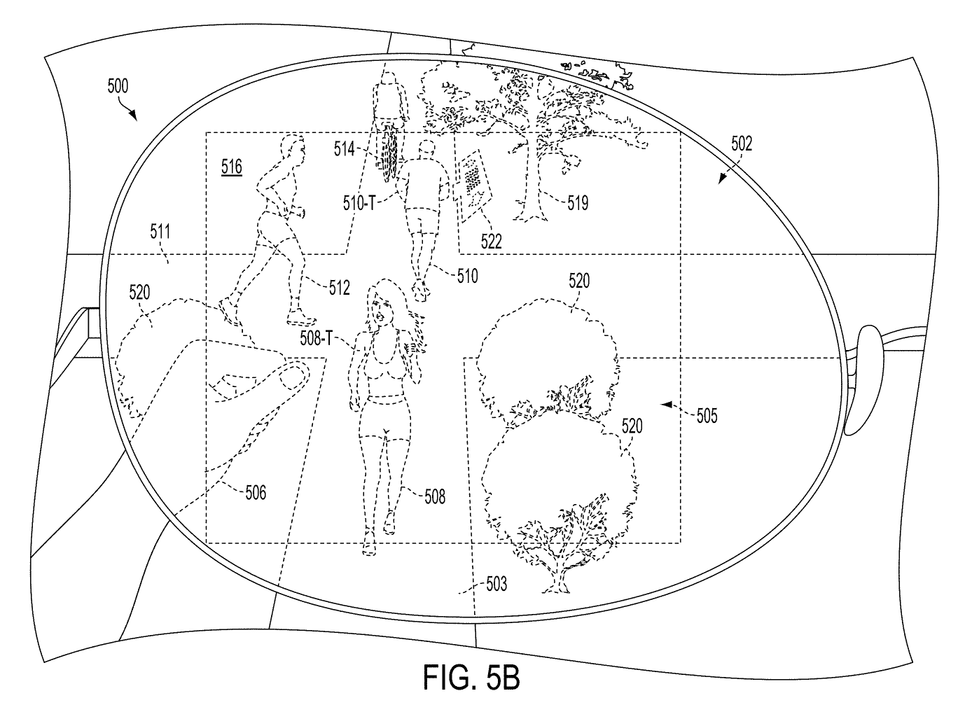

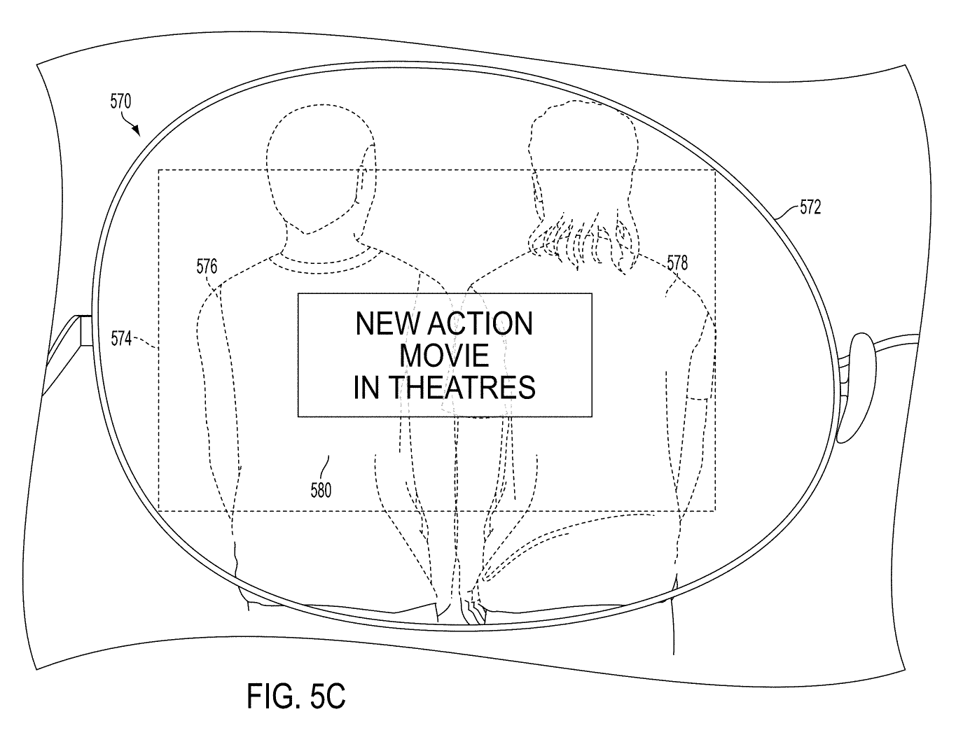

FIG. 5A is a simplified illustration of a real-world field of view 500, according to an embodiment. The real-world field of view 500 is shown from the perspective of the wearer of an HMD 502, who is running on a path 503. FIG. 5A also illustrates various real-world aspects of the wearer-view, which may be analyzed and/or identified in gaze data from HMD 502, and for which the advertising suitability by evaluated using a method such as method 100. In particular, at the moment illustrated in FIG. 5A, real-world field of view 500 includes the wearer's hand 506, a first runner 508, a second runner 510, a third runner 512, a cyclist 514, a grassy area 516, a tree 518, bushes 520, and a sign 522.

In FIG. 5A, the HMD 502 includes a see-through display 504, where it can display graphics that, when the HMD 502 is worn, appear in the wearer's field of view (and thus may be considered to be part of the wearer-view, along with the wearer's real-world surroundings). Further, HMD 502 may include a forward-facing camera (not shown), that captures POV video data. As such, the POV video data may provide substantially capture real-world field of view 500, and thus provide a wearer-view that can be analyzed for advertising background suitability.

In particular, a server system that is in communication with HMD 502 (and/or HMD 502 itself) may carry out block 106 of method 100 by analyzing the wearer-view associated with the HMD 502, and determining a portion of the wearer-view that provides suitable background for advertising. The HMD 502 may then display a selected advertisement in its display 505 such that the advertisement substantially aligns, in the wearer-view, with the suitable area of the wearer's real-world field of view.

To determine the portion of the wearer-view of HMD 502 that provides a suitable advertising background, a server system may evaluate various visual characteristics of the wearer-view; e.g., by identifying a portion of the real-world field of view 500 that has one or more visual characteristics that are suitable as an advertising background. Various types of visual characteristics may be considered when evaluating the suitability of the wearer-view as an advertising background.

Note that some visual characteristics may be considered to be generally indicative of a suitable background portion in the wearer-view (or conversely, indicative of a real-world aspect that generally does not provide a suitable background). Other visual characteristics may be defined as providing a suitable background for a specific advertisement or for a certain type of advertisement (e.g., any advertisement having certain characteristics). Further, some visual characteristics may be defined as generally providing a suitable advertising background or as providing a suitable background for a specific advertisement, but only in a certain context or certain contexts.

D. Examples of Visual Characteristics

Illustrative examples of visual characteristics will now be provided. These examples should not be construed as limiting unless it is explicitly stated to the contrary.

i. Permanence

In some implementations, the server system may evaluate the permanence of various portions of the wearer-view, and seek to identify a portion that has a level of permanence considered suitable for an advertising background. To do so, the server system may evaluate the relative permanence of various aspects of the wearer-view. In particular, the server system may evaluative permanence of aspects relative to the HMD and/or relative to the wearer-view (which may be assumed to be representative of permanence relative to the wearer's field of view). Additionally or alternatively, the permanence of various aspects of the wearer-view may be evaluated in an absolute manner, independent of the HMD's movement. Various techniques and/or various types of information may be utilized to determine the relative and/or absolute permanence of a portion of the wearer-view.

In some implementations, to determine a permanence level of a real-world aspect or aspects relative to the wearer-view, the server system may detect the presence over time of objects and/or features that are captured in POV video from a camera on the HMD, and evaluate how consistently objects and/or features are within the field of view of the camera. As a specific example, if an object is detected in 18 out of 20 consecutive frames in a POV video, then it may be considered to have a 90% permanence level during that timeframe. Other examples are also possible.

In other implementations, permanence level of a real-world aspect may be based on historical permanence data for the real-world aspect (and/or for a similar type of aspect or aspects sharing a common characteristic or characteristics). The historical permanence data may indicate the actual permanence that was observed in past instances in which an advertisement was detected in gaze data. For instance, the historical permanence data may indicate how long, in past instances, an aspect remained in the frame of POV video. Note that this can be tracked for instances in which an advertisement was displayed over the aspect (or similar aspects), and also instances where the aspect (or a similar aspect) is detected in gaze data, but is not used as a background for an advertisement.

As a specific example, consider a scenario where an object is identified in gaze data and is being evaluated as a possible background for an advertisement. In this scenario, the historical permanence data for the identified object indicates that, in the thirty-four of the last forty times the object has been detected in gaze data, the object remained permanent enough with respect to the wearer-view, for an advertisement to be displayed for a certain period of time (e.g., ten seconds). Based on this data, the server system could assume that there is an 85% probability of the object being permanent enough to successfully display an advertisement using the object as a background.

To provide a specific example, consider the scenario shown in FIG. 5A, where the wearer of HMD 502 is running along a path 503. Further, as indicated by the arrows next to the respective runners, first runner 508 is moving towards the wearer, second runner 510 is running in the same direction as the wearer is running, and third runner 512 is running on a path 511 that is perpendicular to and crosses the path 503 that the wearer is running along.

In this scenario, a server system may analyze the wearer-view provided by gaze data from HMD 502, and determine the suitability of various real-world objects and features, which are captured in the wearer-view. In particular, by analyzing the frame of POV corresponding to the real-world field of view 500, and one or more previous frames of the POV video, the server system may detect when first runner 508, second runner 510, and third runner 512 are within the wearer-view, and further, whether their respective presence is persistent enough to conclude that, e.g., a respective runner's shirt is a suitable background for an advertisement.

As a specific example, if runner 510 is running along path 503 in front of the wearer, then runner 508 may be have a relatively low amount of movement relative to the wearer-view, and could theoretically even have no movement relative to the wearer-view (if runner 508 and the wearer are running at exactly the same speed). Accordingly, runner 508 may remain within the wearer-view for more than a threshold period of time (or for more than a threshold number of frames), such that the back of runner 510's shirt may be deemed to be suitable for advertising.

However, as runner 508 is approaching the wearer along path 503, runner 508's speed, relative to the wearer-view, may be much greater than runner 510's speed relative to the wearer-view. As such, runner 508 may move in and out of the wearer-view in less than the threshold period of time (or in less than the threshold number of frames). As a result, the server system may refrain from identifying, e.g., the front of runner 508's shirt as a suitable advertising background. Similarly, if runner 512 crosses in front of the wearer quickly, as runner 512 crosses path 503, runner 512 might not be in the wearer-view long enough to use their shirt as the background for an advertisement. Further, if cyclist 514 is moving at a significantly faster than runner 510, then they may move in and out of the wearer-view too quickly, and their permanence level may never be high enough to consider the cyclist's shirt a suitable advertising background.

Note that in the above examples, permanence was evaluated without regard to the location and movement of an object within the video frame; i.e., for purposes of calculating a permanence level, an object is either considered to be in the frame or not. Thus, the permanence level of an object or feature can simply be a measure that is indicative of the object or feature staying in the wearer's field of view for a certain period or a certain number of frames.

However, the server system may additionally or alternatively consider the movement of objects and/or features within the frame, when evaluating how permanent the objects and/or features are relative to the wearer-view. As such, the permanence level of a portion of the wearer-view can also be a measure that is indicative of or takes into account, how an aspect moves within the wearer's field of view. In particular, an aspect's permanence level may be based at least in part on the direction and/or the velocity of the aspect relative to the wearer. Further, note that in the latter case, an object could move around within the field of view, and still have sufficient permanence to be deemed a suitable background for advertising.

In some implementations, by determining and evaluating the motion (e.g., the direction and/or velocity) of real-world objects and features relative to the wearer-view, a server system may be able to more quickly identify portions of the wearer-view that provide a suitable advertising background. For example, if the server system determines that runner 510 is moving in the same direction as the wearer of HMD 502 (i.e., along path 503), the server system may not wait for as long of a period of time before concluding that runner 510's shirt is a suitable advertising background. Other examples are possible as well.

Note that various techniques may be utilized to evaluate motion in the wearer-view. For example, optical-flow analysis may be performed on point-of-view video captured by the HMD's camera. The resulting optical flow may then be evaluated to identify areas of high movement. Other optical-flow-based techniques are also possible. Further, in addition or in the alternative to optical-flow based techniques, simple pixel (or sub-region) frame differencing techniques could be applied to determine motion based on changes between video frames or changes between sequential still images captured by a camera on an HMD. Other techniques for quantifying and/or evaluating motion in the wearer-view are possible as well.

In a further aspect, a server system may include or have access to aspect-to-permanence mapping data that maps various objects and/or features to pre-defined relative and/or absolute permanence levels. In particular, a server system may use various object-recognition techniques to identify objects and/or types or classes of objects. An object or feature that is identified in the wearer-view may then be cross-referenced against the aspect-to-permanence mapping data to determine the pre-defined permanence level that is associated with the object or feature.

For example, FIG. 5B is a simplified illustration of another real-world field of view 550, according to an embodiment. The real-world field of view 550 is shown in FIG. 5B from the perspective of the wearer (not shown) of an HMD 552. FIG. 5B also illustrates various real-world aspects of the wearer-view, which may be analyzed and/or identified in gaze data from HMD 552, and for which the advertising suitability by evaluated using a method such as method 100. In particular, at the moment illustrated in FIG. 5B, real-world field of view 550 includes a large office building 556.

Accordingly, a server system may receive gaze data from HMD 552, analyze the wearer-view, and detect the office building 556. Note that various well known object-recognition techniques may be used for this purpose. Further, the office building 556 may be generically identified (e.g., as a building or as a large building), and/or may be specifically identified (e.g., identified by name or by address).

In this example, aspect-to-permanence mapping data for the office building may indicate that such a large building should generally be considered permanent. Accordingly, if no other factors indicate to the contrary, the server system may determine that a surface 558 on the wall of the large building 556 provides a suitable background for advertising.

Further, aspect-to-permanence mapping data for the office building could be combined with other indicators of permanence to determine, e.g., that surface 558 provides a suitable advertising background. For example, surface 558 may be identified as being on the side of the office building 556. In addition, historical permanence data for building 556 and/or for the surface 558 may indicate that the office building 556 and/or the surface 558, have typically been permanent enough relative to wearer-views, to provide a suitable advertising background. Based on this combination of factors, the server system may conclude that the permanence of the surface 558 is satisfactory for use as a background for an advertisement. Other examples are also possible.

In a further aspect, observations of movement relative to the wearer-view and/or persistence in the wearer-view may be used in conjunction with pre-defined aspect-to-permanence data to support, confirm, adjust, and/or override the pre-defined level of permanence. More specifically, such pre-defined aspect-to-permanence data may be desirable, as they may allow for a suitable background to be identified more quickly, rather than waiting for an aspect or aspects to remain in the wearer-view for a threshold time period. However, there may also be instances where relying on predetermined observations could lead to unsuitable aspects being selected. Analyzing other factors that are indicative of permanence may thus help to avoid incorrectly identifying an unsuitable aspect as suitable.

For example, real-world field of view 550 includes a bus 560, which has a picture 562 of a building in its side. Relying only on object recognition, the picture 562 of the building might be determined to have a high level of permanence, and thus be identified as a suitable advertising background, in a similar manner as large building 556. However, by analyzing motion within the frame, the server system may determine that bus 560 is moving rapidly through the wearer's field of view. Since the bus 560, along with the picture 562 of the building on the side of the bus, is moving rapidly out the wearer-view, the server system may ignore or reduce the weight given to the pre-defined permanence level, so that an advertisement will not be overlaid on the building in picture 562. Other examples are also possible.

In a further aspect, observations of movement relative to the wearer-view, persistence in the wearer-view, and/or pre-defined aspect-to-permanence mapping data may be combined with context to help assess the permanence of various portions of the wearer-view. For example, the duration for which an aspect must be present in the wearer-view and/or the amount of motion within the wearer view that will be tolerated for a suitable advertising background, can vary depending upon context.

As another example, aspect-to-permanence mapping data may indicate permanence levels for certain aspects in specific contexts. For instance, in the context of an HMD wearer walking on the street or standing on a street corner, a billboard may be pre-defined as having a high permanence relative to the wearer, while a car in the middle of the road (assumed to be driving due to position) may be pre-defined as having a low permanence relative to the wearer. However, in the context of the HMD (and thus the wearer) being in a moving car, a billboard may be pre-defined as having a lower permanence relative to the wearer, while a car in the middle of the road (assumed to be driving due to position) may be pre-defined as having a higher permanence relative to the wearer. Other examples of adjusting the manner in which permanence is assessed, based on context, are also possible.

In a further aspect, by evaluating permanence, a server system may be able to identify a portion of the wearer-view that combines multiple objects and/or features as a suitable background for a single advertisement. This may help to provide some unique advertising opportunities. To provide one example of such a unique advertising opportunity, consider FIG. 5C, which is a simplified illustration of another real-world field of view 570, according to an embodiment. The real-world field of view 550 is shown in FIG. 5C from the perspective of the wearer (not shown) of an HMD 572.

FIG. 5C also illustrates various real-world aspects of the wearer-view, which may be analyzed and/or identified in gaze data from HMD 572, and for which the advertising suitability by evaluated using a method such as method 100. In particular, at the moment illustrated in FIG. 5C, real-world field of view 550 includes two people, person 576 and person 578, standing shoulder to shoulder. If person 576 and person 578 remain shoulder to shoulder for a certain period of time, then the portion of the wearer-view including the backs of both of their shirts may identified as suitable background for advertising. Accordingly, an advertisement 580 may be displayed in the display 574 of HMD 572, such that it is overlaid, in the wearer-view, across the both person 576 and person 578's backs.

Note that FIG. 5C provides an example where analysis of permanence helped to recognize a combination of multiple objects and/or features that are arranged together and found to have permanence over a time period that is adequate to display on advertisement. Such combinations of aspects may be identified even though the combination of aspects are not typically thought of as providing a suitable background due to, e.g., the fact that the aspects typically move independently from one another. Many other examples of such temporarily-available combinations, which may be identified as a suitable background for advertising, are also possible.

ii. Coloration

Many other types of visual characteristics may also be evaluating to determine a portion of the wearer-view that provides a suitable advertising background. For instance, in some implementations, the coloration of a real-world aspect may make the aspect a more or less suitable advertising background. In some cases, the server system may simply consider lighter real-world aspects to be more suitable (e.g., as the background for an ad with dark text). Conversely, for some advertisements, such as those having light text and/or lighter images, darker real-world aspects may be considered a more suitable background. As a specific example, referring back to FIG. 5A, consider the scenario where an HMD needs to display an advertisement that includes text in a dark-colored font (e.g., black text). In this scenario, the HMD 502 may determine that the darker areas in the field of view 500 (e.g., path 503, if it is a black-asphalt running path, for example) provide more suitable advertising backgrounds.

Furthermore, in some implementations, certain colors may be considered more suitable advertising backgrounds. For instance, black, grey, and white tones may be considered more suitable, as they are more neutral colors. On the other hand a neon yellow or green aspect might not be considered suitable, as some wearers might find it more difficult to see advertisements overlaid on such a brightly colored real-world background.

Yet further, the interplay between specific colors may be evaluated. In particular, the server system may consider the relationship between the color or colors in a selected or candidate advertisement and the color or colors in a portion of the wearer-view for which the suitability is being evaluated. For example, if an advertisement includes a significant amount of blue, the server system may consider a real-world aspect of a contrasting color or colors (e.g., white or red), to be a more suitable background than real-world aspects of the same or similar color (e.g., blue or purple). Other examples are also possible.

iii. Patterns

Patterns in real-world objects and/or features provide another visual characteristic that can be evaluated when evaluating the advertising background suitability of the wearer-view. In particular, certain types of visual patterns may be defined as providing a more or less suitable background for advertising. Further, a given pattern may be considered to be generally indicative of a suitable background for advertising. However, a given pattern could also be considered to be indicative of a suitable background for a particular advertisement and/or for an advertisement having a particular characteristic or characteristics.

In some implementations, real-world aspects with simple visual patterns may be considered more suitable (and possibly weighted according to how simple the pattern is), than real-world aspects with complicated or “busy” visual patterns. For example, referring to the scenario illustrated in FIG. 5B, the surface 558 on the wall of the large building 556 may be considered a more suitable background for an advertisement than an area of building 556 that includes windows. Other examples are also possible.

E. Quantifying Suitability of an Advertising Background

Various techniques may be implemented to identify a portion or portions of the wearer-view that provide a suitable background for advertising. As noted, these techniques may utilize various visual characteristics, alone or in combination with one another, to identify a suitable advertising background in the wearer-view.

In some embodiments, a server system may determine an ad-suitability value for one or more portions of the wearer-view. The ad-suitability value for a portion of the wearer-view may thus provide the basis for identifying that the particular portion is suitable as a background for advertising. For example, the server system may analyze gaze data from an HMD and determine a respective ad-suitability value for a number of candidate aspects in the wearer-view. Then, based on the ad-suitability values of the candidate aspects, the server system may identify one or more of the candidate aspects as providing suitable backgrounds for advertising.

In some implementations, the server system may then select a portion of the wearer-view that includes a candidate aspect or aspects with the highest ad-suitability value, as the portion that should provide the background for a particular advertisement. In other implementations, the server system may identify all portions of the wearer-view having greater than a threshold ad-suitability value. Then, as each such portion is identified, the server system may select an advertisement that is appropriate to be overlaid on the particular portion.

The ad-suitability value for a given portion of the wearer-view may be calculated based on measures of various visual characteristics of the wearer-view, such as those described above. In particular, the server system may measure various visual characteristics of the aspect or aspects in a given portion of the wearer-view, to calculate at the ad-suitability value for the given portion.

For example, a permanence level or permanence value may be determined for one or more aspects in a given portion of the wearer-view. In some embodiments, permanence value then compared to threshold or criteria for permanence for individual ads, such that an ad is selected for which aspect meets permanence requirements. Alternatively, the server may weigh permanence level, along with measures of other factors such as the coloration in the wearer-view, the size and/or shape of the portion, the relationship between the content of advertisement and the wearer-view, and/or context information), in order to calculate an ad-suitability value for a portion of the wearer-view.

F. Determining a Location in a See-Through Display that Corresponds to a Suitable Real-World Background

Referring back to block 108 of FIG. 1, method 100 may involve a server system sending an ad-display message to an HMD, which indicates to display an advertisement in a location in the see-through display that corresponds, in the wearer-view, with the portion of the wearer-view that has been determined to provide a suitable advertising background.

Note that in order to determine a portion of the wearer-view that provides a suitable background for the advertisement, the computing system may assume that the wearer-view is indicative of the real-world field of view of a person who is wearing the HMD. Therefore, to determine a suitable aspect or aspects, the server system may identify an area in the gaze data (e.g., in one or more POV images or POV video frames), which has a visual characteristic or characteristics that are defined as suitable.

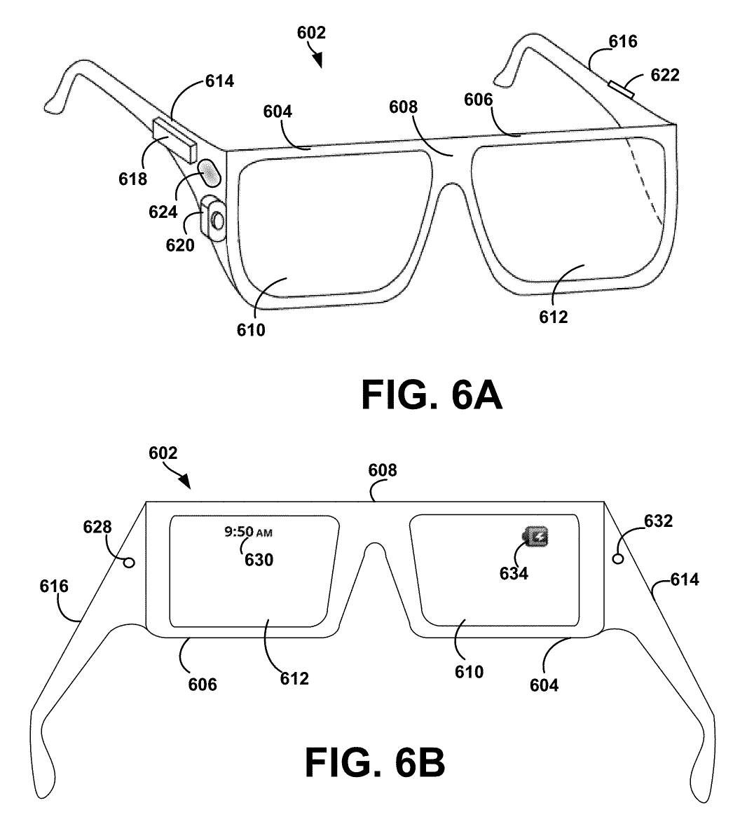

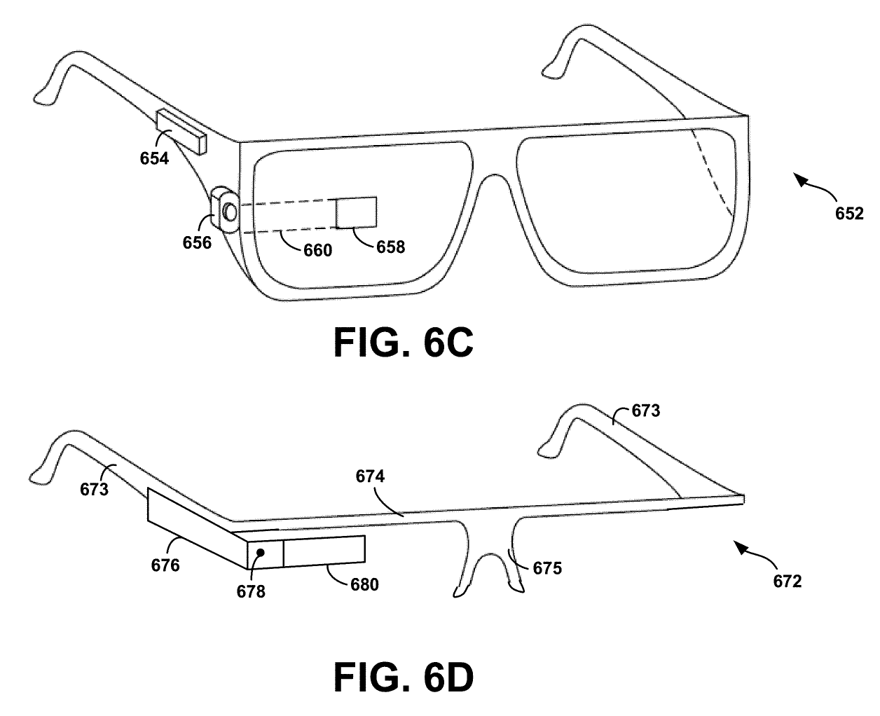

Further, while a point-of-view camera may be mounted on an HMD such that it is close to the wearer's eye, the camera will typically be at least some distance from the eye. Thus, the camera may not be perfectly aligned with the HMD wearer's line of sight through a translucent display, and the perspective captured by the camera may differ to some extent from the wearer's perspective. For example, in FIG. 6C, camera 656 is offset slightly from the display 658. Other examples are also possible.

Due to the offset, an embodiment may take into account a difference between the perspectives provided by the camera on the HMD and the wearer's actual field of view through the HMD's see-through display. In order to help correct for this difference, the HMD and/or a server system supporting the HMD may calculate an offset based on the distance between the user's eye and the camera and/or an angle between the user's line of sight to the translucent display and the camera's alignment. (Note that this offset may be predetermined, or may be calibrated periodically.) This offset may then be applied to the suitable portion of the wearer-view, as identified in POV video from the HMD's camera, in order to determine the corresponding area in the translucent display.

When the computing system limits its analysis to the portion of the image data that corresponds to the real-world background, such as is described above, the size (e.g., area) and location of this portion may be determined based on the positioning of the display relative to the eye. For instance, the computing system may take into account the distance between the display and or the angular relationship between the eye and the display when determining what portion of a video frame or image to analyze. In some embodiments, the size and location of portion 410 may be determined based at least in part on the distance and/or angle between the wearer's eye and the display (e.g., the angle through which the eye rotates from its position when looking straight ahead in order to look at the display).

In some embodiments, the computing system may attempt to determine an area in the video that exactly corresponds to the wearer's real-world background; or in other words, may determine the specific area of the video for analysis based on a particular distance to the eye, a particular angle to the eye, and/or a particular distance and/or angle between the eye and the camera mounted on the HMD. However, the computing system may also expand its analysis beyond the exactly-corresponding area. For example, the computing system may determine an area of the video for analysis that allows for a range of distances and/or a range of angles between the display of the HMD and the wearer's eye. This may be useful to account for variations in facial shape, slippage of the HMD while being worn, and other scenarios that might cause the HMD to move around on the wearer's face such that the positioning of the camera relative to the eye changes.

In a further aspect, there may be scenarios where it is desirable to display an augmented-reality style advertisement such that it is perceived as appearing directly on a real-world surface that is not on a plane perpendicular to viewing axis. In this scenario, an HMD may be configured to warp, curve, and/or keystone the advertisement so that it appears, in the wearer-view, to lay on the surface. Further, note that the ability to modify advertisements to augment a particular surface may be considered when selecting an advertisement for display at the HMD. For example, the server system may favor a first advertisement over a second because the warping that would be needed to augment a particular surface with the first advertisement would be perceived as less extreme and/or less damaging to the viewability of the first advertisement, as compared to the expected perception of the second advertisement after undergoing the warping needed to augment the particular surface with the second advertisement.

### IV. Additional Examples of Ad-Selection Processes

At block 104 of method 100, the ad-selection process may take the wearer-view into account in various ways. In particular, the ad-selection process may use the wearer-view to help select an advertisement that relates to what the wearer is currently viewing. In some embodiments, the server system may identify a set of advertisements that relate in some manner to what the wearer is currently viewing, determine interest values and advertiser-values for the set of advertisements, and select an advertisement (or possibly multiple advertisements) from the set based on the interest values and the advertiser-values for the respective advertisements.

An advertisement may relate to the wearer-view, or aspect(s) thereof, in various ways, depending upon the implementation. For example, wearer-view may be considered during the ad selection process in order to determine a context associated with the HMD from which the corresponding gaze data was received. The ad-selection process may then use the context to help select an advertisement that is more likely to be of interest to the wearer in light of the real-world aspects that are currently being viewed by the wearer. As a specific example, referring back to FIG. 2C, the advertisement message of “$1.00 off any coffee if you buy now” may be selected, at least in part, because it is believed that a wearer who is looking at coffee shop 208 might be interested in a coupon providing a discount at the coffee shop. Other examples are possible as well.

In some cases, the server system may use the wearer-view in combination with other context signals to determine the context upon which ad selection is based. For example, consider again the scenario where coffee shop 208 is detected in the gaze data. However, in this example, it may have been determined that that the wearer was just located inside the coffee shop, and that the wearer purchased coffee while inside the shop. This context may be derived by analyzing the gaze data and determining that the wearer is holding a cup of coffee, handed money to an employee of the coffee shop, and so on, as well as by evaluating other sources of context information, such as location (e.g., inside the coffee shop) and/or information from the a credit-card account that the wearer associated with their user-profile, which indicates the wearer just purchased coffee. When such context is detected, the server system may accordingly determine that it is not a desirable to offer the wearer a coupon for “$1.00 off any coffee if you buy now.” Accordingly, the server may refrain from sending the coupon to the HMD in this context. Note that this example also illustrates how historical context information may be used to determine a current context.

As another example, consider a scenario where gaze data from an HMD indicates a television in an electronics store is within the wearer's field of view. Further, the HMD may send eye-tracking data to the server system. If it is detected that a user is staring at the television for a certain period of time (e.g., based on the eye-tracking data), it may be inferred that the wearer is interested in the television, as compared to other aspects of the wearer-view. Therefore, an advertisement for the television (and possibly advertisements for other comparable televisions sold by the store) may be selected for display by the HMD. For instance, the advertisement might indicate promotions or sales related to the television and/or might provide technical specifications of the television. Many other specific examples are also possible.

In a further aspect, the ad-selection process may additionally or alternatively take the wearer-view into account when determining the interest value and/or when determining the advertiser-value for a given advertisement. In particular, since the wearer-view may be indicative of the wearer's current environment and/or situation, the wearer-view may provide context that affects the interest value and/or the advertiser-value. As such, the interest value and/or the advertiser-value may be adjusted according to the context provided by the wearer-view.

In some embodiments, the wearer-view may be analyzed not only to determine which advertisement should be displayed by the HMD, but also which version or format of an advertisement should be displayed. For instance, a set of advertisement variations may be provided for a given product, with each variation in the set including different characteristics and/or features. As a specific example, consider a set of advertisements for a car in which the car is shown in blue or yellow, and in which either a man or woman is shown in the car, thus providing four possible variations. Over time, the server system may analyze gaze data associated with a given user-profile, and observe that the associated wearer spends more time looking at women than at men, and more time looking at blue cars than at yellow cars. As such, the historical wearer-view may provide context for determining which advertisement from the set should be selected for the wearer. In particular, the server system may select the variation of the car advertisement showing a woman driving a blue car. Many other examples are possible as well.

In some embodiments, the wearer-view may additionally or alternatively be considered during the ad selection process to determine whether or not it is an appropriate context to display an advertisement in the HMD's display. For instance, a server system may analyze POV video from the HMD (and possibly other context signals associated with the HMD), and detect that the wearer seems to be riding a bus. The server system may determine that it is appropriate for the HMD to display an ad while the wearer is riding the bus, and thus may select an ad based on, e.g., information provided by the user-profile that is currently associated with the HMD. However, if the HMD concludes that the wearer is currently driving, it may conclude that selection of an ad for display by the HMD is not appropriate, and refrain from doing so.

In another aspect, the server system may analyze the wearer-view to identify one or more aspects of the wearer-view that are appropriate for visual advertisement augmentation, and then attempt select an advertisement that will augment the identified aspect or aspects. For instance, referring back to FIGS. 2A to 2C, the selection of visual highlights 204, 214, and 224, may be based upon detecting the coffee shop 208 and/or the “Coffee Shop” sign 206 in the wearer-view. Other examples are also possible.

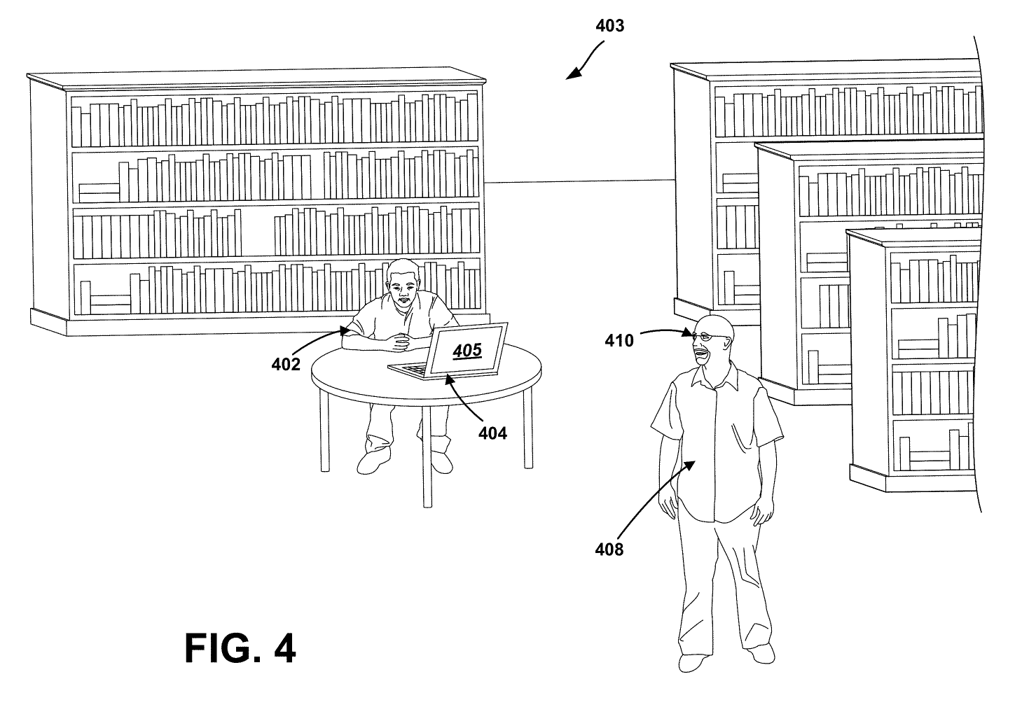

To further illustrate the analysis of the wearer-view for an aspect that is appropriate for visual advertisement augmentation, consider FIG. 4, which illustrates a scenario in which an advertisement may be selected to augment a real-world aspect of the wearer-view, according to an exemplary embodiment. More specifically, FIG. 4 illustrates a scenario in which method 100 may be used to select an advertisement or advertisements for display in a manner that augments the back of the screen of a laptop computer, which is identified in the wearer-view. (For purposes of this example, the back of the laptop-computer screen may simply be referred to as a “laptop space.”)

In particular, FIG. 4 shows a user 402 of a laptop computer 404, who is in a library 403 while working on the laptop computer 404. In a further aspect, FIG. 4 illustrates a wearer 408 of a wearable computing device 410, who is located near to user 402. Thus, as shown, wearer 422 may view laptop computer 404 while user 402 is sitting in library 403.

Further, HMD 410 may be configured to send gaze data, such as point-of-view video, to the ad-selection server. As such, when wearer 408 views the laptop space 405, point-of-view video from HMD 410 may capture the laptop space 405. Accordingly, when an ad-selection server receives and analyzes the gaze data from wearable computing device 410, the ad-selection server may detect laptop space 405 in the wearer-view associated with HMD 410. As such, ad-selection server may select one or more advertisements to augment the laptop space 405 in the wearer-view provided by HMD 410.

When ad-selection server detects laptop space 405 in the gaze data, the ad-selection server may interpret this as an indication that wearer 408 is viewing laptop space 405. Accordingly, the ad-selection server may then attempt to determine if there is information related to wearer 408 that can be used to select an ad that is likely to interest wearer 408. In particular, the ad-selection server may access a user-profile for wearer 408 and use information included in and/or accessible via the user-profile to select an advertisement. The ad-selection server may also determine the advertiser-value for various candidate advertisements. The ad-selection server may then utilize the combination of the interest values and the advertiser-values for various candidate advertisements when selecting an advertisement for display at the HMD.

As a specific example, if the user-profile for wearer 408 indicates that wearer 408 is a 35-year-old female who has historically purchased a new car every five years, and who last purchased a car four years and ten months ago, then the ad-selection may use this information to select an advertisement for display by HMD 410. In particular, since this information indicates that wearer 408 may be interested in buying a new car soon, the server system may determine interest values and advertiser-values for various new car advertisements.

Then, based on the interest values and the advertiser-values for the new-car advertisements, the system may select a particular new-car advertisement and send it to HMD 410. For instance, based on the user-profile for wearer 408, the system may identify a first and second new-car advertisements in which the wearer 408 is most interested. Further, if the first new-car advertisement has already been displayed to the wearer, while the second new-car advertisement has not, the advertiser-value for the second new-car advertisement may be greater than the advertiser-value for the first. Accordingly, the server system may select the second new-car advertisement and send it to the HMD 410.

In some embodiments, the server system may select more than one advertisement. In such an embodiment, the server system may indicate to HMD 410 to rotate the selected advertisements. For instance, continuing the above example, the server system may send a number of new-car advertisements HMD 410 (e.g., those having the highest overall display value), along with instructions to display a rotation of the new-car advertisements such that each advertisement augments laptop space 405, in the wearer-view. Further, the ad-selection server may rank the new-car advertisements based on their respective overall display values, so that the rotation of the advertisements in laptop space 405 can be ordered based on the ranking.

Note that while the rotation of advertisements in the above example includes advertisements that are of the same type (e.g., advertisements for cars), there is no requirement that the advertisements in a rotation be of the same type. A rotation of advertisements that is selected may include various different types of advertisements, which need not be similar to one another in any particular regard, other than having been selected using an ad-selection process such as described in reference to method 100.

At block 104 of method 100, the ad-selection process may take the associated user-profile into account in various ways. In particular, information from the user-profile may be used to help select an advertisement that is likely to be of interest to the user associated with the user-profile.

For example, the selection of an advertisement may be based on data included in or accessible from the user-profile such as: (a) income data, (b) consumer data providing information such as purchase history, spending habits, locations of purchases, amounts of purchases, types or categories of purchases, timing of purchases, etc., (c) purchase-history data, (d) demographic data such as age or age group, ethnicity, nationality, sex, location of residence, and/or location of workplace, (e) user-preferences indicated by the user-profile, (f) data from the user's social network account contact and/or social networking information, such as a wearer's contacts (e.g., a wearer's “friends” on the social network), and possibly data indicating a purchasing influence of the wearer with regard to their contacts (e.g., data indicating any correlation of the wearer's purchasing history to the wearers' friends' purchasing histories), (g) data from the user's e-mail account, (h) web-browsing history associated with the user-profile, (i) a computer-based calendar associated with the user-profile, (j) information from an electronic account with a financial institution (e.g., data from credit card accounts, bank accounts, investment accounts, etc.), and/or (k) other information such as income, job or job type, other job details, hobbies, interests, and so on. Other data from a user-profile or otherwise associated with a given user may also be used to select an ad for display to the user on their HMD.

In a further aspect, a user-profile may include or provide access to historical wearer-view data for the user. The historical wearer-view data may include statistics and other data related to advertisements that have been viewed by the user in the past. To facilitate such functionality, an exemplary system may be configured to generate wearer-view data for a given user-profile when advertisements are sent for display at the associated HMD (and possibly when sent for display at other devices associated with the user-profile). By doing so over time, an exemplary system may build up historical wearer-view data that can be considered when selecting an advertisement for display.

Further, the ad-selection process may take context into account when evaluating information from a user-profile. For instance, consider a user-profile that indicates the particular user is a scientist who is interested in the latest research in their field. The user-profile may also indicate that the scientist enjoys building model airplanes in their spare time, and typically purchases supplies for the model airplanes at a local hobby store. Therefore, it may be determined that the scientist will likely be interested in an advertisement for an upcoming conference in their field, as well as an advertisement for a sale on model airplanes at the local hobby store. This context information may then be utilized when selecting an advertisement for display at the scientist's HMD.

As a specific example, consider a scenario where the scientist is driving to work at their laboratory. In this scenario, context signals such as the day of the week, time, and/or the scientist's location may be used to determine that the scientist is “driving to work at their lab” (e.g., based on context signals indicating that the scientist is located on a highway along the route to the laboratory, on a weekday, at 8:00 am). Since the scientist is driving to work, a server system may determine that the scientist will likely be more interested in the advertisement for upcoming conference in their field, and take this into account when selecting an advertisement for display at the scientist's HMD.

At a later time, if the server system detects the scientist is driving home from work (e.g., based on context signals indicating that the scientist is located on a highway along the route from the laboratory, on a weekday, at 5:00 pm), it may be inferred that the scientist would rather see non-work-related advertisements. Accordingly, the server system may determine that, in this context, the scientist will likely be more interested in the advertisement for the local hobby store, and take this into account when selecting an advertisement for display at the scientist's HMD.

Context may be taken into account in numerous ways when determining an expected interest of the wearer in a particular advertisement. Use of context and context signals is described in more detail below.

Further, it should be understood that an exemplary ad-selection process may utilize almost any type of information relating to a given user, so long as the user has given permission for such information to be used for purposes of selecting and providing advertisements for them.

At block 104 of method 100, the ad-selection process may take advertiser-value into account in various ways. For example, when determining whether to select the advertisement for display at the HMD, the advertiser-value may be combined with or weighed against the interest value for an advertisement.

The value to an advertiser of displaying an advertisement may be measured in a number of different ways, and may take into account various factors that are indicative of the value to the advertiser from the particular user viewing a given ad. For instance, the advertiser-value may be based on an expected return to the advertiser from the particular user viewing the advertisement and/or the context in which the advertisement is being viewed (e.g., the amount a user would spend if they act on the advertisement multiplied by the probability the particular user will act).

Note that in some instances, the particular wearer's interest in viewing an advertisement and the value to the advertiser of the wearer viewing the advertisement may be positively correlated. In particular, displaying an advertisement to an interested wearer may be more valuable to the advertiser than displaying an advertisement to an uninterested wearer. Therefore, in some embodiments, advertiser-value may be based on factors that are indicative of the likelihood that a given user will be interested in a particular advertisement. However, since there may be a positive correlation between the interest value and the advertiser-value for the advertisement, this correlation may be taken into account when using the interest value and the advertiser-value for a given advertisement to determine the overall display value for the advertisement.

Note that in other instances, the wearer's interest and the advertiser-value counteract each other, and thus are negatively correlated. For example, consider a user who is extremely interested in an advertisement for an expensive sports car and only somewhat interested in an advertisement for an economy car, but has historically has always purchased economy cars. In such case, the advertisement for the economy car may be selected over the ad for the sports car, since it does interest the user to some extent, and provides a much greater value to the advertiser. Other examples are also possible.

In instances where the interest value and the advertiser-value are positively or negatively correlated, the ad-selection process may take such positive and/or negative correlation into account. Further, it is possible that in some instances, there may be no correlation between the interest value and advertiser-value.

In some embodiments, historical data regarding the past display of a particular advertisement and/or similar advertisements may be considered when determining the advertiser-value. For example, in some cases, diminishing returns may be expected as an advertisement or similar advertisements (e.g., different advertisements for the same product) are repeatedly shown to the same user. Accordingly, the server system may reduce the advertiser-value for an advertisement when the advertisement or similar advertisements have been previously displayed by devices associated with the same user-profile. In such an embodiment, the server system may use historical display data to adjust the advertiser-value in a binary manner (e.g., based on whether or not the advertisement has already been displayed to the wearer), or to adjust the advertiser-value in a more granular manner (e.g., based on the specific number of times the advertisement has been displayed to the wearer).

In other cases, the past display of related advertisements may not reduce the advertiser-value, and in some cases, may increase the advertiser-value. For example, when evaluating the value to an advertiser of displaying an advertisement for a certain product, the server system may increase the advertiser-value for the advertisement when another advertiser's advertisement for a competing product has already been displayed to the wearer, and/or when the advertisement for the competing product has been displayed a greater number of times to the wearer than the advertisement being evaluated for selection. Other examples are also possible.

In some embodiments, the advertiser-value may be adjusted based on the context associated with the HMD. For example, consider a scenario where an advertisement is being selected for a user who spends more money going to movies than a typical user, who is located within walking distance of a movie theater, and who has nothing scheduled in their mobile phone's calendar for the next three hours. In this scenario, display of an advertisement for a movie playing at a nearby movie may be considered to be valuable to the advertiser, since there may be a higher probability that showing this advertisement to this user will result in the user going to see the movie, than there is for other users. Accordingly, the advertisement for the movie at the nearby movie theater may be selected and displayed at the HMD.

Context may be taken into account in numerous other ways, and in numerous other scenarios, when determining the advertiser-value. Use of context and context signals is described in more detail below.

In a further aspect, increasing the recognition of a brand may be of interest and value to an advertiser. Therefore, in some embodiments, the server system may additionally or alternatively consider brand value and/or value derived from building a brand, when determining the advertiser-value. Note that the brand-building that results from displaying an advertisement at an HMD may provide a positive the contribution to advertiser-value, regardless of whether it triggers a purchase or provides value in some other measurable way.

In some cases, the contribution of brand-building to the advertiser-value of displaying an advertisement at a particular HMD, may vary depending upon characteristics of the wearer to which the advertisement is being displayed (e.g., based on the user-profile that is associated with the HMD). For example, the same incremental increase in brand recognition with a billionaire may be considered more valuable to the advertiser than the same increase in brand recognition with a high-school freshman, who does not have the same spending power as the billionaire.

As another example, a wearer who has a thousand “friends” on the social-network account that is associated with their user-profile, may be considered more to the have more influence with others than a wearer who has only ten friends on their associated social-network account. Therefore, the same incremental increase in brand recognition with the wearer who has a thousand “friends” on their social-network account, may be considered more valuable to the advertiser than the same increase in brand recognition with the wearer who has only ten friends on their social-network account.

It should be understood that other factors may be considered when determining the advertiser-value, in addition or in the alternative to the factors described above. Furthermore, as the above-described techniques are provided for illustrative purposes, it should be understood that other techniques for determining the value to the advertiser of displaying a given advertisement at a given HMD are possible.

In a further aspect, the selection of an advertisement that is more likely to interest a given user and/or that increases the value provided to the advertiser, does not necessarily correspond to an increase in the amount that the advertiser is ultimately charged. While this may be the case in some embodiments, other embodiments may involve charging a lesser amount to an advertiser because their advertisement is more likely to interest a certain user and/or because the advertisement is more valuable to the advertiser.

While this may seem counter-intuitive in one sense, this strategy of charging less for more valuable advertisement selection may provide long-term gains. In particular, by displaying advertisements that are likely to interest users, the advertising as a whole may gain credibility with the viewing public, which may result in more people viewing advertisements in the long-term. Put another way, if people are disinterested in an advertisement that is displayed to them, they may choose not to view and/or ignore advertisements that are displayed in the future and/or request that advertisements not be displayed to them in their HMD. Therefore, by reducing the amount charged for advertising that interests users, advertisers are incentivized to provide advertising that is interesting. Providing such incentivizes may in turn increase the chances for long-term success in the advertising space and similar types of advertising spaces, thus creating more long term value for the seller and/or a third-party that is brokering advertisement sales.

### V. Wearable-Computer-Based Functionality

The above-described methods and systems are generally described with reference to examples where a wearable computing device sends gaze data to a server system or systems, and where the server system or systems generally provide most of the functionality for selecting advertisements for display at an HMD. Such an implementation might also be referred to as a “cloud-based” implementation. However, it should be understood that wearable-computer-based implementations and partially cloud-based implementations are also possible. Thus, it should be understood that some or all of the functionality that is described herein as being carried out by a server system may alternatively be carried out at a wearable computing device, such as an HMD.

As such, a wearable computing device, such as an HMD, may carry out functions that are analogous or similar to those of method 100 that are described above as being carried out by a server system. For example, a wearable computing device, which includes a see-through display, may receive gaze data that is indicative of a wearer-view through a see-through display. The device may then analyze the gaze data to determine at least one aspect of the wearer-view that is suitable as a background for advertising. The device may also send an ad-space availability message, which indicates the at least one determined aspect of the wearer-view, to a server system. The ad-space availability message may inform the server system that the aspect that provides suitable advertising background has been detected, and possibly provide characteristics of the aspect and/or characteristics desired in the advertisement to be selected.

The device may then receive an ad-display message, which is responsive to the ad-space availability message, and which indicates an advertisement to display over the identified aspect of the wearer-view. Accordingly, the wearable computing device may display the indicated advertisement at a location in the see-through display that substantially aligns, in the wearer-view, with the determined aspect of the wearer-view.

In other embodiments, rather than rely on the server system to select an advertisement, a wearable computing device may itself select the advertisement to display. For example, a number of advertisements could be downloaded and stored at the HMD, such that the advertisements are available for display when the HMD detects appropriate circumstances to do so. The HMD could obtain advertisement for such purposes in various ways and at various times. For instance, the HMD could download advertisements when, for example, the HMD is plugged in to recharge, such that the download process does not drain the battery. Other examples are possible as well.

### VI. Exemplary Wearable Computing Devices

FIG. 6A illustrates a wearable computing system according to an exemplary embodiment. In FIG. 6A, the wearable computing system takes the form of a head-mountable device (HMD) 602 (which may also be referred to as a head-mountable display). It should be understood, however, that exemplary systems and devices may take the form of or be implemented within or in association with other types of devices, without departing from the scope of the invention. As illustrated in FIG. 6A, the head-mountable device 602 comprises frame elements including lens-frames 604, 606 and a center frame support 608, lens elements 610, 612, and extending side-arms 614, 616. The center frame support 608 and the extending side-arms 614, 616 are configured to secure the head-mountable device 602 to a user's face via a user's nose and ears, respectively.

Each of the frame elements 604, 606, and 608 and the extending side-arms 614, 616 may be formed of a solid structure of plastic and/or metal, or may be formed of a hollow structure of similar material so as to allow wiring and component interconnects to be internally routed through the head-mountable device 602. Other materials may be possible as well.

One or more of each of the lens elements 610, 612 may be formed of any material that can suitably display a projected image or graphic. Each of the lens elements 610, 612 may also be sufficiently transparent to allow a user to see through the lens element. Combining these two features of the lens elements may facilitate an augmented reality or heads-up display where the projected image or graphic is superimposed over a real-world view as perceived by the user through the lens elements.

The extending side-arms 614, 616 may each be projections that extend away from the lens-frames 604, 606, respectively, and may be positioned behind a user's ears to secure the head-mountable device 602 to the user. The extending side-arms 614, 616 may further secure the head-mountable device 602 to the user by extending around a rear portion of the user's head. Additionally or alternatively, for example, the HMD 602 may connect to or be affixed within a head-mountable helmet structure. Other possibilities exist as well.

The HMD 602 may also include an on-board computing system 618, a video camera 620, a sensor 622, and a finger-operable touch pad 624. The on-board computing system 618 is shown to be positioned on the extending side-arm 614 of the head-mountable device 602; however, the on-board computing system 618 may be provided on other parts of the head-mountable device 602 or may be positioned remote from the head-mountable device 602 (e.g., the on-board computing system 618 could be wire- or wirelessly-connected to the head-mountable device 602). The on-board computing system 618 may include a processor and memory, for example. The on-board computing system 618 may be configured to receive and analyze data from the video camera 620 and the finger-operable touch pad 624 (and possibly from other sensory devices, user interfaces, or both) and generate images for output by the lens elements 610 and 612.

The video camera 620 is shown positioned on the extending side-arm 614 of the head-mountable device 602; however, the video camera 620 may be provided on other parts of the head-mountable device 602. The video camera 620 may be configured to capture images at various resolutions or at different frame rates. Many video cameras with a small form-factor, such as those used in cell phones or webcams, for example, may be incorporated into an example of the HMD 602.

Further, although FIG. 6A illustrates one video camera 620, more video cameras may be used, and each may be configured to capture the same view, or to capture different views. For example, the video camera 620 may be forward facing to capture at least a portion of the real-world view perceived by the user. This forward facing image captured by the video camera 620 may then be used to generate an augmented reality where computer generated images appear to interact with the real-world view perceived by the user.

The sensor 622 is shown on the extending side-arm 616 of the head-mountable device 602; however, the sensor 622 may be positioned on other parts of the head-mountable device 602. The sensor 622 may include one or more of a gyroscope or an accelerometer, for example. Other sensing devices may be included within, or in addition to, the sensor 622 or other sensing functions may be performed by the sensor 622.

The finger-operable touch pad 624 is shown on the extending side-arm 614 of the head-mountable device 602. However, the finger-operable touch pad 624 may be positioned on other parts of the head-mountable device 602. Also, more than one finger-operable touch pad may be present on the head-mountable device 602. The finger-operable touch pad 624 may be used by a user to input commands. The finger-operable touch pad 624 may sense at least one of a position and a movement of a finger via capacitive sensing, resistance sensing, or a surface acoustic wave process, among other possibilities. The finger-operable touch pad 624 may be capable of sensing finger movement in a direction parallel or planar to the pad surface, in a direction normal to the pad surface, or both, and may also be capable of sensing a level of pressure applied to the pad surface. The finger-operable touch pad 624 may be formed of one or more translucent or transparent insulating layers and one or more translucent or transparent conducting layers. Edges of the finger-operable touch pad 624 may be formed to have a raised, indented, or roughened surface, so as to provide tactile feedback to a user when the user's finger reaches the edge, or other area, of the finger-operable touch pad 624. If more than one finger-operable touch pad is present, each finger-operable touch pad may be operated independently, and may provide a different function.

FIG. 6B illustrates an alternate view of the wearable computing device illustrated in FIG. 6A. As shown in FIG. 6B, the lens elements 610, 612 may act as display elements. The head-mountable device 602 may include a first projector 628 coupled to an inside surface of the extending side-arm 616 and configured to project a display 630 onto an inside surface of the lens element 612. Additionally or alternatively, a second projector 632 may be coupled to an inside surface of the extending side-arm 614 and configured to project a display 634 onto an inside surface of the lens element 610.

The lens elements 610, 612 may act as a combiner in a light projection system and may include a coating that reflects the light projected onto them from the projectors 628, 632. In some embodiments, a reflective coating may not be used (e.g., when the projectors 628, 632 are scanning laser devices).

In alternative embodiments, other types of display elements may also be used. For example, the lens elements 610, 612 themselves may include: a transparent or semi-transparent matrix display, such as an electroluminescent display or a liquid crystal display, one or more waveguides for delivering an image to the user's eyes, or other optical elements capable of delivering an in focus near-to-eye image to the user. A corresponding display driver may be disposed within the frame elements 604, 606 for driving such a matrix display. Alternatively or additionally, a laser or LED source and scanning system could be used to draw a raster display directly onto the retina of one or more of the user's eyes. Other possibilities exist as well.

FIG. 6C illustrates another wearable computing system according to an exemplary embodiment, which takes the form of an HMD 652. The HMD 652 may include frame elements and side-arms such as those described with respect to FIGS. 6A and 6B. The HMD 652 may additionally include an on-board computing system 654 and a video camera 656, such as those described with respect to FIGS. 6A and 6B. The video camera 656 is shown mounted on a frame of the HMD 652. However, the video camera 656 may be mounted at other positions as well.

As shown in FIG. 6C, the HMD 652 may include a single display element 658 which may be embedded in the lens element and coupled to the device. The display element 658 may be formed on one of the lens elements of the HMD 652, such as a lens element described with respect to FIGS. 6A and 6B, and may be configured to overlay computer-generated graphics in the user's view of the physical world. The display element 658 is shown to be provided in a center of a lens of the HMD 652; however, the display element 658 may be provided in other positions.

The display element 658 may be implemented in various ways. For example, display element 658 is illustrated as being an optical see-through display, which is controllable via the computing system 654 that is coupled to the display element 658 via an optical waveguide 660. Other types of optical see-through displays are also possible. Further, an HMD may implement other types of near-eye displays, such as a video see-through display or an optical see-around display, without departing from the scope of the invention.

FIG. 6D illustrates another wearable computing system according to an exemplary embodiment, which takes the form of an HMD 672. The HMD 672 may include side-arms 673, a center frame support 674, and a bridge portion with nosepiece 675. In the example shown in FIG. 6D, the center frame support 674 connects the side-arms 673. The HMD 672 does not include lens-frames containing lens elements. The HMD 672 may additionally include an on-board computing system 676 and a video camera 678, such as those described with respect to FIGS. 6A and 6B.

The HMD 672 may include a single display element 680 that may be coupled to one of the side-arms 673 or the center frame support 674. The display element 680 may be configured in a similar manner as described with reference to FIG. 6C, and may be configured to overlay computer-generated graphics upon the user's view of the physical world. In one example, the single display element 680 may be coupled to the inner side (i.e., the side exposed to a portion of a user's head when worn by the user) of the extending side-arm 673. The single display element 680 may be positioned in front of or proximate to a user's eye when the HMD 672 is worn by a user. For example, the single display element 680 may be positioned below the center frame support 674, as shown in FIG. 6D.

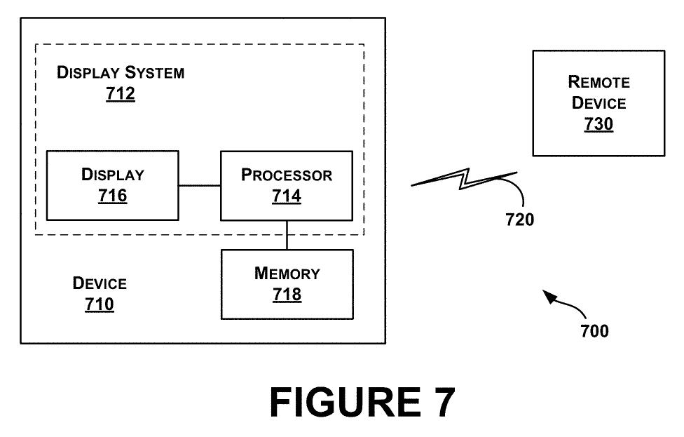

FIG. 7 illustrates a schematic drawing of a computing device according to an exemplary embodiment. In system 700, a device 710 communicates using a communication link 720 (e.g., a wired or wireless connection) to a remote device 730. The device 710 may be any type of device that can receive data and display information corresponding to or associated with the data. For example, the device 710 may be a heads-up display system, such as the head-mountable devices 602, 652, or 672 described with reference to FIGS. 6A-6D.

Thus, the device 710 may include a display system 712 comprising a processor 714 and a display 716. The display 710 may be, for example, an optical see-through display, an optical see-around display, or a video see-through display. The processor 714 may receive data from the remote device 730, and configure the data for display on the display 716. The processor 714 may be any type of processor, such as a micro-processor or a digital signal processor, for example.

The device 710 may further include on-board data storage, such as memory 718 coupled to the processor 714. The memory 718 may store software that can be accessed and executed by the processor 714, for example.

The remote device 730 may be any type of computing device or transmitter including a laptop computer, a mobile telephone, or tablet computing device, etc., that is configured to transmit data to the device 710. The remote device 730 and the device 710 may contain hardware to enable the communication link 720, such as processors, transmitters, receivers, antennas, etc.

In FIG. 7, the communication link 720 is illustrated as a wireless connection; however, wired connections may also be used. For example, the communication link 720 may be a wired serial bus such as a universal serial bus or a parallel bus. A wired connection may be a proprietary connection as well. The communication link 720 may also be a wireless connection using, e.g., Bluetooth® radio technology, communication protocols described in IEEE 802.11 (including any IEEE 802.11 revisions), Cellular technology (such as GSM, CDMA, UMTS, EV-DO, WiMAX, or LTE), or Zigbee® technology, among other possibilities. The remote device 730 may be accessible via the Internet and may include a computing cluster associated with a particular web service (e.g., social-networking, photo sharing, address book, etc.).

### VII. Server Systems

In general, an exemplary system may be implemented in or may take the form of a server system or a component thereof. For instance, an exemplary system may take the form of non-transitory computer readable medium, which has program instructions stored thereon that are executable by at a processor to provide the functionality described herein. An exemplary system may also take the form of a computing device itself, a subsystem of such a device, or a combination of multiple computing devices, which include a non-transitory computer readable medium having such program instructions stored thereon.

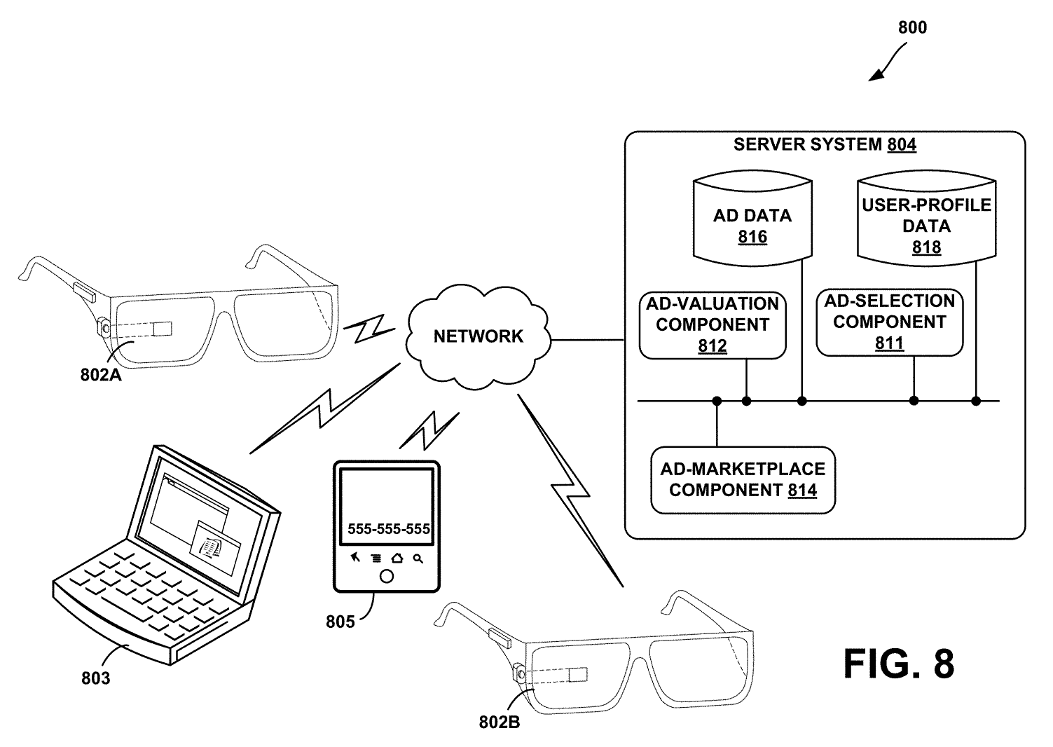

FIG. 8 is a simplified block diagram illustrating a communication network via which gaze data may be received, according to an exemplary embodiment. As shown, communication network 800 includes a number of wearable computing devices 802A and 802B, which are configured to communicate with a server system 804 via one or more networks 806. As such, server system 804 may be configured to receive gaze data from wearable computing devices 802A and 802B, which may be HMDs or may take another form. The server system 804 may then utilize the gaze data to carry out functions of a method, such as method 100 of FIG. 1, to select an ad for display at a wearable computing device 802A or 802B.

In order to facilitate an exemplary method, the users of wearable computing devices 802A and 802B may register their respective devices and opt in to programs via which the users of these devices submit gaze data from their respective devices. Further, a user may agree to use of their gaze data for various purposes, such as for valuing advertisements, for valuing the user's own gaze, for determining the value to the advertiser of the user viewing an advertisement in the display of their HMD, and/or for providing advertising and/or other information that is customized for the user. As such, wearable computing devices 802A and 802B may send gaze data to the server system 804 so that the server system 804 can select and/or determine when advertisements should be displayed at the wearable computing devices 802A and 802B.

As noted, the gaze data in an exemplary embodiment may include point-of-view videos captured by a number of wearable computing devices. For example, some or all of the wearable computing devices 802A and 802B may include or take the form of glasses-style HMDs that each include a forward-facing video camera for taking point-of-view video (e.g., video that generally captures the perspective of a person wearing the HMD). As such, when the HMD is worn, the forward-facing camera will capture video and/or images that are generally indicative of what the wearer of the HMD sees. Note that exemplary glasses-style HMDs will be described in greater detail with reference to FIGS. 6A, 6B, 6C, 6D, and 7.

In a further aspect, communication network 800 may also include computing devices other than wearable computing devices, such as laptop computer 803 and mobile phone 805, for instance. Other types of computing devices are also possible. In such an embodiment, laptop 803, mobile phone 805, and/or other computing devices may provide supplemental gaze data, which may be used by server system 804 to supplement the gaze data from wearable computing devices 802A and 802B.

The server system 804 may be a computing system including one or more computing devices. In particular, server system 804 may be a cloud-based server system that is configured for server-system functions described herein. In the illustrated example, server system 804 may include or be in communication with an ad-selection component 811, an ad-valuation component 812 and an ad-marketplace component 814, which are configured for various advertisement-related functions (and possibly other functions as well), including functions based on gaze data from wearable computing devices 802A and 802B.

In some embodiments, ad-selection component 811, ad-valuation component 812 and ad-marketplace component 814 may take the form of or include software, hardware, and/or firmware for providing the functionality described herein. In particular, these components may include program instructions stored in a tangible computer-readable medium that are executable to provide the functionality described herein, and possibly to provide other functionality as well.

Further, each of components 811, 812, and 814 may be a subsystem of a computing device, a computing device unto itself, or may be a system that includes one or more computing devices. For instance, each of components 811, 812, and 814 may be a separate server system, which includes one or more computing devices. Alternatively, some or all of the functionality attributed to ad-selection component 811, ad-valuation component 812, and/or ad-marketplace component 814 may be provided by a combined server system, which may include one or more computing devices. Further, other types and combinations of hardware, software, and/or firmware may provide some or all of the functionality of ad-selection component 811, ad-valuation component 812, and/or ad-marketplace component 814, without departing from the scope of the invention. Other variations on the illustrated arrangement of components are also possible.

In a further aspect, server system 804 may include or have access to various databases including data that may be utilized to provide the functionality described herein. In the illustrated example, server system 804 includes an advertisement database 816 and a user-profile database 818. Other databases are also possible.

Further, note that while advertisement database 816 and user-profile database 818 are shown as separate databases, some or all of the data described as being stored advertisement database 816 and/or user-profile database 818 may be combined in a common database or in various other arrangements of databases. Additionally or alternatively, advertisement database 816 and/or user-profile database 818 may each be implemented by multiple databases. Yet further, while advertisement database 816 and user-profile database 818 are illustrated as components of server system 804, some or all of these databases may be included in a separate computing system or systems that are accessible to server system 804. Other variations on the illustrated arrangement of databases are also possible.

Advertisement database 816 may include data identifying and/or describing advertisements that are available for display at an HMD. In an exemplary embodiment, advertisement database 816 may include data indicating characteristics of users and/or types of users for which specific advertisements are intended. Accordingly, ad-selection component 811 may be configured to utilize the advertisement data stored in advertisement database 816 to help select an advertisement that is more likely to appeal to the wearer of a given wearable computing device.

Yet further, in order to determine which advertisement or advertisements are likely to appeal to the wearer of a given wearable computing device, user-profile database 818 may include user-profile data for a number of users, may provide access to other sources of data related to users, and/or may indicate other storage locations for data relating users. The user-profile data stored in or accessible via user-profile database 818 may therefore be helpful in determining what type of advertisement may appeal to a given user.

In some instances, an identifier for the associated user-profile may be included in the gaze data. In this case, ad-selection component 811 may use the identifier to locate user-profile data for the associated user-profile in user-profile database 818.

However, in other instances, gaze data may not indicate the associated user-profile. As such, user-profile database 818 may also include data that allows ad-selection component 811 to determine a user-profile that corresponds to the HMD from which the gaze data is received. For example, a user may pre-associate the user's wearable computing device (e.g., the user's HMD) with their user-profile, such as by registering their device with server system 804. As such, when ad-selection component 811 receives gaze data, it may determine which wearable computing device 802A provided the gaze data (e.g., by using an identifier of the wearable computing device included in the gaze data), and then determine the user-profile that is currently associated with the wearable computing device 802A.

In either case, ad-selection component 811 may monitor the wearer-view indicated by the gaze data from a wearable computing device 802A for aspects of the wearer-view that are appropriate for augmentation with advertisement. When such an aspect is detected, ad-selection component 811 may access user-profile data stored in user-profile database 818, and in particular, may access the user-profile that is associated with the wearable computing device 802A from which the gaze data was received. Information from the associated user-profile may then be used to select an advertisement for display at the wearable computing device 802A. For example, ad-selection component 811 may compare and/or match advertisement preferences and/or characteristics from the associated user-profile to characteristics of candidate advertisements, as indicated by advertisement data in advertisement database 816. Based on this comparison, the ad-selection component 811 may select one or more advertisements having characteristics that match up well with the preferences and/or characteristics indicated by the associated user-profile.

In a further aspect, an exemplary server system 804 may be configured to provide advertisements described or stored in ad database 816 for display at wearable computing devices 802A and 802B.

In FIG. 8, communications between the various devices 802A, 802B, 803, 805, the server system 804 are illustrated as being conducted via wireless connections; however, wired connections may additionally or alternatively be used. For example, an exemplary embodiment may conduct wired communications via a wired serial bus such as a universal serial bus or a parallel bus, or via another type of wired connection. A wired connection may be a proprietary connection as well. Further, wireless communications may utilize various different types of wireless connections and protocols such as Bluetooth® radio technology, communication protocols described in IEEE 802.11 (including any IEEE 802.11 revisions), Cellular technology (such as GSM, CDMA, UMTS, EV-DO, WiMAX, or LTE), and/or Zigbee technology, among other possibilities.

It should be understood that the arrangements shown in FIG. 8 and described herein are provided for illustrative purposes, and are not intended to be limiting. Those skilled in the art will understand that variation on the illustrated arrangement and other arrangements are possible, without departing from the scope of the invention.

### VIII. CONCLUSION

It should be understood that the terms “head-mounted display,” “head-mounted device,” “head-mountable display,” and “head-mountable display” can be used interchangeably. In particular, these terms may refer to a wearable computing device that, when worn, provides or supports at least one near-eye display. It should be further understood that such a device may be considered to be a head-mounted display whether it is worn or not; i.e., such a device is simply mountable and is not necessarily worn at any given point in time, unless it is explicitly specified as being worn.

It should also be understood that for situations in which the embodiments discussed herein collect and/or use any personal information about users or information that might relate to personal information of users, the users may be provided with an opportunity to opt in/out of programs or features that involve such personal information (e.g., information about a user's preferences or a user's contributions to social content providers). In addition, certain data may be anonymized in one or more ways before it is stored or used, so that personally identifiable information is removed. For example, a user's identity may be anonymized so that no personally identifiable information can be determined for the user and so that any identified user preferences or user interactions are generalized (for example, generalized based on user demographics) rather than associated with a particular user.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A computer-implemented method comprising:
receiving, by a computing device, gaze data that is indicative of a wearer-view comprising real-world surroundings, wherein the wearer-view is associated with a head-mountable device (HMD) comprising a see-through display;
selecting, by the computing device, a given advertisement for display in the see-through display;
analyzing the gaze data and one or more characteristics of the given advertisement to determine a non-conceptual visual relationship between content of the given advertisement and subject matter in at least a portion of the real-world surroundings in the wearer-view;
based at least in part on the determined visual non-conceptual relationship, the computing device determining that the portion of the real-world surroundings is visually suitable as an advertising backdrop for the given advertisement, wherein determining that the portion of the real-world surroundings is visually suitable as an advertising backdrop comprises determining that the portion of the real-world surroundings has a level of permanence suitable for an advertising backdrop;
determining a location in the see-through display that corresponds, in the wearer-view, with the determined portion of the wearer-view that is visually suitable as the advertising backdrop; and
sending an ad-display message from the computing device, wherein the ad-display message indicates to the HMD to display the given advertisement at the location in the see-through display that corresponds, in the wearer-view, with the determined portion of the wearer-view that is visually suitable as the advertising backdrop.

2. The method of claim 1, wherein the wearer-view comprises a real-world field of view associated with the HMD.

3. The method of claim 1, wherein selecting the given advertisement for display in the see-through display comprises using one or more characteristics of the wearer-view as a basis for selecting the given advertisement.

4. The method of claim 1, wherein determining that the portion of the real-world surroundings is visually suitable as an advertising backdrop further comprises:
determining an ad-suitability value for the portion the wearer-view; and
using the ad-suitability value as a basis for determining that the portion of the wearer-view is suitable as a backdrop for the given advertisement.

5. The method of claim 1, wherein determining that the portion of the real-world surroundings is visually suitable as an advertising backdrop further comprises identifying at least one aspect of the wearer-view that has an ad-suitability value that is greater than a threshold value.

6. The method of claim 1, wherein determining that the portion of the real-world surroundings is visually suitable as an advertising backdrop further comprises:
determining a respective ad-suitability value for each of a plurality of candidate aspects of the wearer-view; and
based on the respective ad-suitability values of the candidate aspects, selecting one of the candidate aspects as the aspect that is suitable as an advertising backdrop.

7. The method of claim 1, wherein determining the visual non-conceptual relationship between the given advertisement and the portion of the real-world surroundings in the wearer-view comprises comparing coloration of at least the portion of the wearer-view to the one or more characteristics of the given advertisement.

8. The method of claim 1, determining the visual non-conceptual relationship between the given advertisement and the portion of the real-world surroundings in the wearer-view comprises comparing a visual pattern of at least the portion of the wearer-view to the one or more characteristics of the given advertisement.

9. A computer-implemented method comprising:
receiving, by a computing device, gaze data that is indicative of a wearer-view comprising real-world surroundings, wherein the wearer-view is associated with a head-mountable device (HMD) comprising a see-through display;
selecting, by the computing device, a given advertisement for display in the see-through display;
analyzing, by the computing device, the gaze data to determine a non-conceptual relationship between the given advertisement and a portion of the real-world surroundings in the wearer-view, wherein the non-conceptual relationship comprises a measure of permanence of the portion of the real-world surroundings, wherein the measure of permanence is determined based at least in part on historical permanence data indicative of permanence of the portion of the real-world surroundings observed in past instances;
based at least in part on the determined non-conceptual relationship comprising the measure of permanence, the computing device determining that the portion of the real-world surroundings is suitable as an advertising backdrop for the given advertisement;
determining a location in the see-through display that corresponds, in the wearer-view, with the determined portion of the wearer-view that is suitable as the advertising backdrop; and
sending an ad-display message from the computing device, wherein the ad-display message indicates to the HMD to display the given advertisement at the location in the see-through display that corresponds, in the wearer-view, with the determined portion of the wearer-view that is suitable as the advertising backdrop.

10. The method of claim 9, wherein the measure of permanence indicates a probability of at least one real-world object or feature remaining within the wearer-view during a predetermined period of time.

11. The method of claim 9, further comprising determining the measure of permanence, wherein determining the measure of permanence comprises:
identifying at least one object that is located in a particular portion of the wearer-view; and
using aspect-to-permanence mapping data to determine a pre-defined permanence level that is associated with the at least one identified object.

12. The method of claim 9, wherein the measure of permanence is determined based at least in part on a context associated with the HMD.

13. (canceled)

14. A system comprising:
a non-transitory computer-readable medium; and
program instructions stored on the non-transitory computer-readable medium and executable by at least one processor to:
receive gaze data that is indicative of a wearer-view comprising real-world surroundings, wherein the wearer-view is associated with a head-mountable device (HMD) comprising a see-through display;
select a given advertisement for display in the see-through display;
analyze the gaze data and one or more visual characteristics of the given advertisement to determine a visual non-conceptual relationship between the given advertisement and a portion of the real-world surroundings in the wearer-view;
based at least in part on the determined visual non-conceptual relationship, determine that the portion of the real-world surroundings is visually suitable as an advertising backdrop for the given advertisement, wherein determining that the portion of the real-world surroundings is visually suitable as an advertising backdrop comprises determining that the portion of the real-world surroundings has a level of permanence suitable for an advertising backdrop;
determine a location in the see-through display that corresponds, in the wearer-view, with the determined portion of the wearer-view that is visually suitable as the advertising backdrop; and
send an ad-display message, wherein the ad-display message indicates to the HMD to display the given advertisement at the location in the see-through display that corresponds, in the wearer-view, with the determined portion of the wearer-view that is visually suitable as the advertising backdrop.

15. The system of claim 14, wherein the program instructions stored on the non-transitory computer-readable medium and executable by at least one processor to determine that the portion of the real-world surroundings that is visually suitable as an advertising backdrop comprise program instructions stored on the non-transitory computer-readable medium and executable by at least one processor to:
determine an ad-suitability value for the portion of the wearer-view; and
use the ad-suitability value as a basis for determining that the portion of the wearer-view is visually suitable as a backdrop for the given advertisement.

16. The system of claim 14, wherein the program instructions stored on the non-transitory computer-readable medium and executable by at least one processor to analyze the gaze data and the one or more characteristics of the given advertisement to determine the visual non-conceptual relationship comprise:
program instructions stored on the non-transitory computer-readable medium and executable by at least one processor to compare one or more visual characteristics of the wearer-view to the one or more characteristics of the given advertisement.

17. The system of claim 16, wherein the one or more visual characteristics comprise a coloration.

18. The system of claim 16, wherein the one or more visual characteristics comprise a visual pattern.

19. (canceled)

20. A non-transitory computer-readable medium having program instructions stored thereon that are executable by at least one processor, the program instructions comprising:
instructions for, at a wearable computing device comprising a see-through display, receiving gaze data that is indicative of a wearer-view through the see-through display;
instructions for analyzing the gaze data and one or more characteristics of the given advertisement to determine a visual non-conceptual relationship between the given advertisement and a portion of the real-world surroundings in the wearer-view;
instructions for determining, based at least in part on the determined visual non-conceptual relationship, that the portion of the real-world surroundings in the wearer-view is visually suitable as an advertising backdrop for the given advertisement, wherein determining that the portion of the real-world surroundings is visually suitable as an advertising backdrop comprises determining that the portion of the real-world surroundings has a level of permanence suitable for an advertising backdrop;
instructions for sending an ad-space availability message that indicates the at least one determined aspect of the wearer-view;
instructions for receiving an ad-display message that is responsive to the ad-space availability message, wherein the ad-display message indicates an advertisement;
instructions for determining a location in the see-through display that substantially aligns, in the wearer-view, with the determined aspect of the wearer view; and
instructions for displaying the indicated advertisement at the location in the see-through display that substantially aligns, in the wearer-view, with the determined aspect of the wearer-view.
